(19) United States
(12) Patent Application Publication
(10) Pub. No.: US 2026/0290774 A1
(43) Pub. Date: Sep. 24, 2026

(54) THREAD PATTERNS FOR SAMPLER CONE

(71) Applicant: PerkinElmer Scientific Canada ULC, Woodbridge (CA)

(72) Inventor: Hamid Badiei, Woodbridge (CA)

(21) Appl. No.: 19/087,026

(22) Filed: Mar. 21, 2025

(51) Int. Cl. H01J 49/04; H01J 49/10

(52) U.S. Cl. CPC H01J 49/04; H01J 49/105

(57) ABSTRACT

The present disclosure relates to a thread pattern of a sampler cone preferably used to seal an interface region of an ICP-MS instrument. The thread design seeks to provide a thread pattern with a smaller total threaded area on the outer sidewall of the sampler cone to decrease the amount of engagement between the threads and the system. The thread pattern may comprise unthreaded regions circumferentially arranged around the shaft of the sampler cone. The thread pattern may also comprise varying thread heights to allow fewer wear surfaces on the sampler cone to decrease the likelihood of galling.

### FIELD

This disclosure relates generally to thread patterns on sampler cones.

### BACKGROUND

Mass spectrometry (MS) is an analytical technique that measures the mass-to-charge ratio of ions in different samples or mixtures. MS techniques can vary depending on what ionization technique they use. For instance, Inductively Coupled Plasma Mass Spectrometry (ICP-MS) uses inductively coupled plasma to ionize the sample. In ICP-MS, ions are first generated in the plasma. The generated ions then pass through an interface region consisting of a series of cones. The series of cones extract the ions from the plasma and transmit the ions to the high vacuum MS detector.

The series of cones are located in an interface region between the atmospheric inductively coupled plasma (ICP) and the high vacuum MS detector. The series of cones may include both a sampler cone and a skimmer cone. The sampler cone is the first component of the interface region and is responsible for sampling the ions generated in the plasma and transmitting them in the following lower pressure areas. As an interface component, the sampler cone should create a vacuum seal on the interface plate to prevent any air or gasses from leaking through. Many sampler cones are attached using a thread pattern. Sampler cones are also located in front of inductively coupled plasma, which can reach temperatures of up to 10,000 K. Because of the extremely high temperatures, sampler cone threads generally omit lubrication. Sampler cones may be exposed to corrosive liquids and thus are generally manufactured from metals that can tolerate those corrosive samples, such as alloys of nickel, copper, aluminum, or platinum.

Sampler cones experience high turnover and frequent removal and reinstallation. Over time, sampler cones may wear down or accumulate buildup that can impact performance of the spectrometer interface. If the sampler cone experiences significant buildup, the sampler cone will need to be removed and cleaned. In severe cases, a sampler cone with significant buildup may impact performance of the spectrometer or may get stuck inside the spectrometer. When this occurs, the sampler cone can be challenging to remove and may result in maintenance of the entire interface resulting in unnecessary downtime and delays.

### SUMMARY

This summary is provided to introduce a selection of concepts in a simplified form that are further described below in the Detailed Description. The Summary is not intended to identify key features or essential features of the claimed subject matter, nor is it intended to be used to limit the scope of the claimed subject matter.

The disclosure is directed to a thread pattern of a sampler cone used in a mass spectrometry instrument. Inductively Coupled Plasma Mass Spectrometry (ICP-MS) is an analytical technique used across a variety of industries. An ICP-MS instrument is made up of many components, including sampler cones. Sampler cones are generally attached to the system using a thread pattern. The sampler cone should create a vacuum seal on the interface plate of the system to prevent any air or gasses from leaking through.

Sampler cones are exposed to an aggressive environment within the ICP-MS instrument. For instance, sampler cones are located in front of plasma and must withstand temperatures up to 10,000 K. Sampler cones may also be exposed to highly corrosive samples. As a result, sampler cones are generally made out of a metallic material resistant to corrosion and with long-lasting properties. Additionally, the exposure to high temperatures and highly corrosive samples may mean that the sampler cones need to be cleaned more frequently than other components. As a result, sampler cones experience frequent removal and reinstallation. However, this can lead to possible galling on the sampler cone threads.

Galling may occur when two metals rub together and create friction, resulting in the release of small amounts of metallic material. While galling can usually be mitigated with proper lubrication, sampler cones generally omit any lubrication due their exposure to high temperatures and instrument contamination. Therefore, when a sampler cone is threaded into the system, the metal threads may rub against the internal metal threads of the ICP-MS instrument. As the sampler cone is frequently inserted and removed, the threads may wear down and release small amounts of metal material. This metal material can get trapped along the threads and may even form lumps. As the sampler cone continues to get removed and reinserted, the lumps will continue to wear down the threads, resulting in threads with a non-smooth surface. Over time, the frequent removal and reinstallation sampler cones may wear down the thread surfaces and/or accumulate buildup that can impact the performance of the spectrometer. In severe cases, threads with significant buildup may impact the performance of the spectrometer or may get stuck inside the spectrometer instrument. When this occurs, the sampler cone can be challenging to remove and may result in maintenance of the entire spectrometry instrument, resulting in unnecessary downtime and delays.

Therefore, a sampler cone thread pattern may be preferred that provides a total threaded area that may be less than similarly sized cones in order to advantageously decrease the amount of contact between the sampler cone threads and the internal threads on the instrument.

According to one example of this disclosure, the sampler cone may provide a relatively smaller total thread area by having a thread pattern with a quantity of unthreaded regions around the outer surface of a threaded insert used to attach the sampler cone to an ICP-MS instrument. The unthreaded regions may provide a total threaded area that is less than similarly sized cones while still allowing the sampler cone to fully screw into the ICP-MS instrument. For example, a thread pattern with a quantity of unthreaded regions may decrease the amount of chafing between the metal threads of the sampler cone and the instrument, resulting in less material being removed and/or transferred from the threads.

Additionally or alternatively, a thread pattern with a quantity of unthreaded regions may provide an outlet for any metal particles that might get caught between the threads. Therefore, rather than have those particles get trapped in the threads and continue to wear away the thread surface, the particles can escape the threads and be deposited in those gaps as the cone is threaded onto and off the system. The height and width of the unthreaded regions may be different according to various examples of the sampler cone.

According to another example of this disclosure, the sampler cone may provide a relatively smaller total thread area by decreasing the thread heights. A gradually increasing thread height may be preferable on the thread pattern of the sampler cone to decrease the likelihood of galling by allowing fewer wear surfaces on the threads of the threaded portion.

Additionally or alternatively, a thread pattern with gradually increasing and decreasing thread heights may also comprise a combination of non-continuous threads and continuous threads. For example, the thread pattern may have at least one continuous thread at the far end of the threaded insert of the sampler cone to facilitate successful engagement of the sampler cone with the internal threads of the ICP-MS instrument without encumbrance or difficulty. Alternative configurations or thread patterns may also be used.

### BRIEF DESCRIPTION OF THE DRAWINGS

The present disclosure is illustrated by way of example and is not limited in the accompanying figures in which like reference numerals indicate similar elements.

FIG. 1A depicts an isometric view of an example sampler cone, according to one or more aspects described herein.

FIG. 1B depicts an isometric view of the sampler cone shown in FIG. 1A.

FIG. 1C depicts an isometric view of the sampler cone shown in FIG. 1A.

FIG. 2A depicts a rear isometric view of an example sampler cone, according to one or more aspects described herein.

FIG. 2B depicts a rear isometric view of the sampler cone shown in FIG. 2A.

FIG. 2C depicts a rear isometric view of the sampler cone shown in FIG. 2A.

FIG. 3A depicts a first side view of an example sampler cone, according to one or more aspects described herein.

FIG. 3B depicts a first side view of the sampler cone shown in FIG. 3A.

FIG. 3C depicts a first side view of the sampler cone shown in FIG. 3A.

FIG. 4A depicts a second side view of an example sampler cone, according to one or more aspects described herein.

FIG. 4B depicts a second side view of the sampler cone shown in FIG. 4A.

FIG. 4C depicts a second side view of the sampler cone shown in FIG. 4A.

FIG. 5A depicts an isometric view of an example sampler cone, according to one or more aspects described herein.

FIG. 5B depicts a side view of an example sampler cone, according to one or more aspects described herein.

FIG. 6A depicts a third side view of an example sampler cone, according to one or more aspects described herein.

FIG. 6B depicts a third side view of the sampler cone shown in FIG. 6A.

FIG. 6C depicts a third side view of the sampler cone shown in FIG. 6A.

FIG. 7A depicts a fourth side view of an example sampler cone, according to one or more aspects described herein.

FIG. 7B depicts a fourth side view of the sampler cone shown in FIG. 7A.

FIG. 7C depicts a fourth side view of the sampler cone shown in FIG. 7A.

FIG. 8A depicts a side view of an example sampler cone, according to one or more aspects described herein.

FIG. 8B depicts a side view of an example sampler cone, according to one or more aspects described herein.

FIG. 8C depicts a side view of an example sampler cone, according to one or more aspects described herein.

FIG. 9A depicts a front view of an example sampler cone, according to one or more aspects described herein.

FIG. 9B depicts a front view of the sampler cone shown in FIG. 9A.

FIG. 9C depicts a front view of the sampler cone shown in FIG. 9A.

FIG. 10A depicts a rear view of an example sampler cone, according to one or more aspects described herein.

FIG. 10B depicts a rear view of the sampler cone shown in FIG. 10A.

FIG. 10C depicts a rear view of the sampler cone shown in FIG. 10A.

FIG. 11A depicts a side view of an example sampler cone, according to one or more aspects described herein.

FIG. 11B depicts a longitudinal cross-sectional view of the sampler cone shown in FIG. 11A.

FIG. 12A depicts an isometric view of an example sampler cone, according to one or more aspects described herein.

FIG. 12B depicts an isometric view of the sampler cone shown in FIG. 12A.

FIG. 12C depicts an isometric view of the sampler cone shown in FIG. 12A.

FIG. 13A depicts a side view of an example sampler cone, according to one or more aspects described herein.

FIG. 13B depicts a side view of the sampler cone shown in FIG. 13A.

FIG. 13C depicts a side view of the sampler cone shown in FIG. 13A.

FIG. 14A depicts a front view of an example sampler cone, according to one or more aspects described herein.

FIG. 14B depicts a front view of the sampler cone shown in FIG. 14A.

FIG. 14C depicts a front view of the sampler cone shown in FIG. 14A.

FIG. 15A depicts a rear view of an example sampler cone, according to one or more aspects described herein.

FIG. 15B depicts a rear view of the sampler cone shown in FIG. 15A.

FIG. 15C depicts a rear view of the sampler cone shown in FIG. 15A.

FIG. 16B depicts a lateral cross-sectional view of the sampler cone shown in FIG. 12A.

FIG. 16A depicts a lateral cross-sectional view of an example sampler cone, according to one or more aspects described herein.

FIG. 16B depicts a lateral cross-sectional view of a second example sampler cone, according to one or more aspects described herein.

FIG. 16C depicts a lateral cross-sectional view of a third example sampler cone, according to one or more aspects described herein.

FIG. 16D depicts a lateral cross-sectional view of a fourth example sampler cone, according to one or more aspects described herein.

FIG. 17A depicts an isometric and side view of an example sampler cone, according to one or more aspects described herein.

FIG. 17B depicts an isometric and side view of a second example sampler cone, according to one or more aspects described herein.

Further, it is to be understood that the drawings may represent the scale of different component of one single example; however, the disclosed examples are not limited to that particular scale.

### DETAILED DESCRIPTION

For the purpose of promoting an understanding of the principles of the present disclosure, reference will be made to the implementations illustrated in the drawings, and specific language will be used to describe them. It will nevertheless be understood that no limitation of the scope of the disclosure is intended. Any alterations and further modifications to the described devices, instruments, methods, and any further application of the principles of the present disclosure are fully contemplated as would normally occur to one skilled in the art to which the disclosure relates. It is fully contemplated that the features, components, and/or steps described with respect to one or more implementations or figures may be combined with the features, components, and/or steps described with respect to other implementations or figures of the present disclosure. For simplicity, in some instances, the same or similar reference numbers are used throughout the drawings to refer to the same or like parts.

Mass spectrometry (MS) is an analytical technique that measures the mass-to-charge ratio of ions in different samples or mixtures. MS techniques can vary depending on the ionization technique they use. For instance, Inductively Coupled Plasma Mass Spectrometry (ICP-MS) uses inductively coupled plasma to ionize the sample. In ICP-MS, ions are first generated in the plasma. The generated ions then pass through an interface region consisting of a series of cones. The series of cones extract the ions from the plasma and transmit the ions to the high vacuum MS detector.

The series of cones are located in an interface region between the atmospheric ICP and the high vacuum MS detector. The series of cones may include both a sampler cone and a skimmer cone. The sampler cone is the first component of the interface region and is responsible for sampling the ions generated in the plasma and transmitting them in the following lower-pressure areas. As an interface component, the sampler cone should create a vacuum seal on the interface plate to prevent any air or gasses from leaking through. Many sampler cones are attached using a thread pattern. Sampler cones are also located in front of inductively coupled plasma, which can reach temperatures of up to 10,000 K. Because of the extremely high temperatures, sampler cones generally omit any lubrication on its threads. Sampler cones may be exposed to corrosive liquids and thus are generally manufactured from metals that can tolerate those corrosive samples, such as alloys of nickel, copper, aluminum, or platinum.

Sampler cones experience high turnover and frequent removal and reinstallation. Over time, sampler cones may wear down or accumulate buildup that can impact the performance of the spectrometer. If the sampler cone experiences significant buildup, the sampler cone will need to be removed and cleaned. In severe cases, a sampler cone with significant buildup may impact the performance of the spectrometer or may get stuck inside the spectrometer machine. When this occurs, the sampler cone can be challenging to remove and may result in maintenance of the entire spectrometer, resulting in unnecessary downtime and delays.

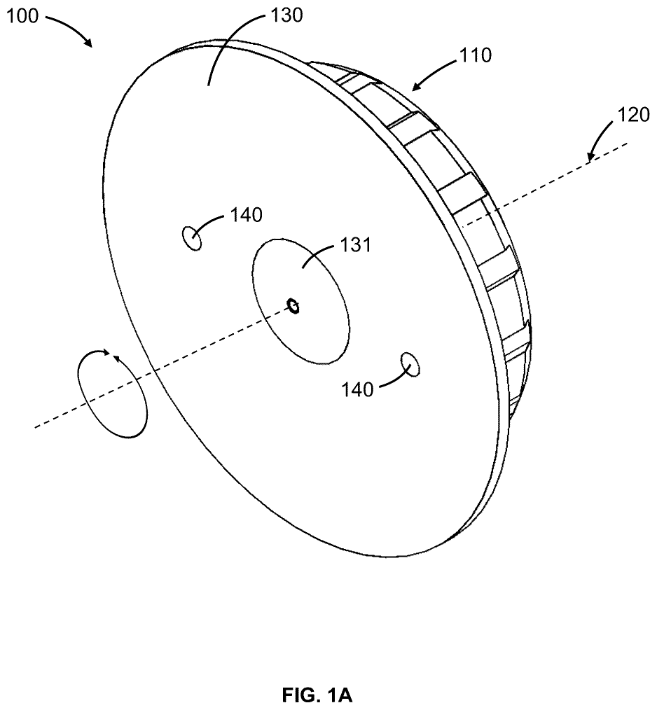

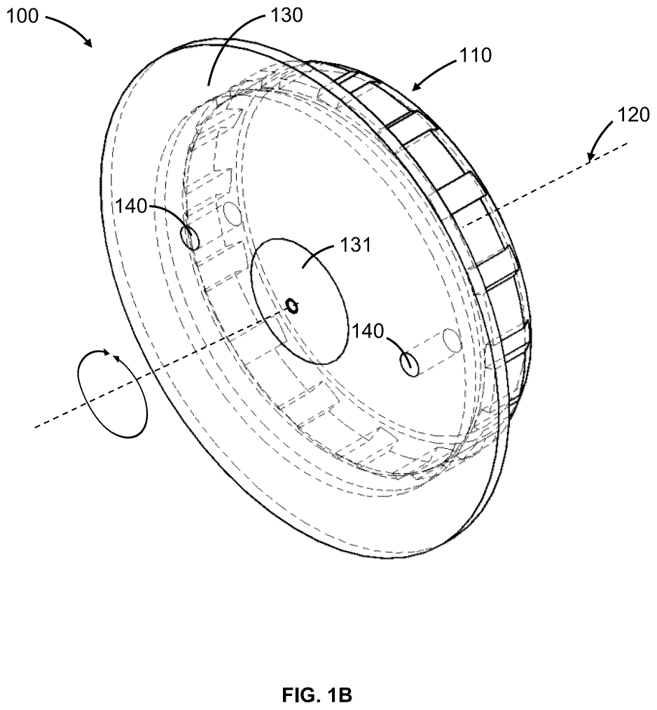

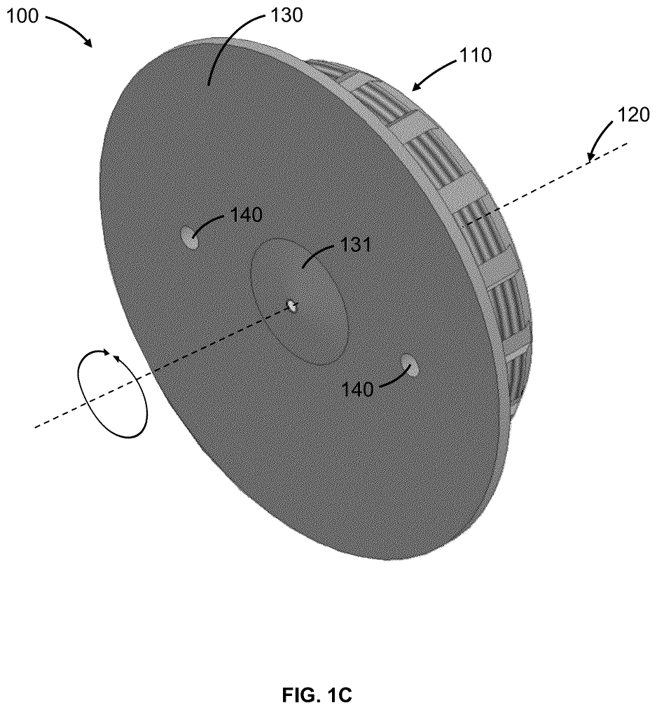

FIGS. 1-17 illustrate multiple views of an example sampler cone 100, according to one or more aspects described herein.

The sampler cone 100 may be configured to removably-couple to and seal an opening or interface of an ICP-MS instrument. Although the sampler cone 100 described herein is preferably used with an ICP-MS instrument, it should be understood that the sampler cone 100 may be any sealing or interface component to which employing a thread pattern with a smaller total threaded area may be advantageous. Therefore, other configurations of the sampler cone 100 may have different shapes, materials, and the like without departing from the principles of the present teachings.

FIGS. 1A-1C depict an isometric view of the sampler cone 100, an isometric wire-view of the sampler cone 100, and an isometric solid-view of the sampler cone 100, respectively. As shown in FIGS. 1A-1C, the sampler cone 100 may comprise a threaded insert 110 (or threaded body) configured to rotate in a direction of rotation around a central longitudinal axis 120. The threaded insert 110, in this example, has a cylindrical shape and extends along an axial direction that is parallel with the central longitudinal axis 120. The threaded insert 110 has an axial length (or simply length) that extends along the axial direction. Multiple rows of threads may be circumferentially disposed on the outer surface of the threaded insert. In some examples, a sample cone may include 5-12 rows (e.g., 10 rows of threads). For convenience and without limitation, the threaded insert 110 is also referred to herein as a threaded shaft or simply a shaft. The direction of rotation may be clockwise or counterclockwise and is configured to fit with a corresponding direction of rotation of a complementary-shaped ICP-MS interface or the like.

The sampler cone 100 may comprise an mounting flange 130 (or simply flange) extending radially outward from the central longitudinal axis 120. The flange 130, in this example, has an annular or circular shape. The flange 130 may have a diameter and an axial width. When the sampler cone 100 is fully engaged, the flange 130 may sit substantially flush against an ICP-MS interface plate (not pictured) to close an opening of the interface and provide a vacuum seal between the ICP-MS instrument and the external environment. In various implementations, the flange may have different shapes (e.g., other than annular or circular), may have different dimensions (e.g., smaller or larger diameters), and may include additional or alternative features not shown in FIGS. 1A-C.

A cone-shaped tip 131 is concentric with and disposed on one side of the flange 130 in this example. The cone-shaped tip may have different dimensions (e.g., height, diameter, diameter-to-height ratio, etc.) in various implementations. The tip 131 includes an orifice that permits passage of an ion sample through the sampler cone 100.

The sampler cone 100 may have additional features to allow a user to easily connect and disconnect the sampler cone 100 to the interface of the ICP-MS instrument. For instance, the flange 130 may have holes 140 that correspond to a key or tool that allows a user to rotate the sampler cone 100 and fully engage or disengage the sampler cone 100 with the ICP-MS instrument.

The sampler cone 100 may be formed from a suitable metallic material, or a combination of suitable metallic materials. For example, a suitable material may be a metallic material resistant to corrosion. A suitable material may also be a metallic material with long-lasting properties. The sampler cone 100 described herein is preferably manufactured partially or wholly from a nickel alloy. The sampler cone 100 may additionally or alternatively be manufactured from other suitable materials or a combination of other suitable materials (e.g., metallic materials), including platinum, copper, aluminum, or the like, as well as combinations of such materials.

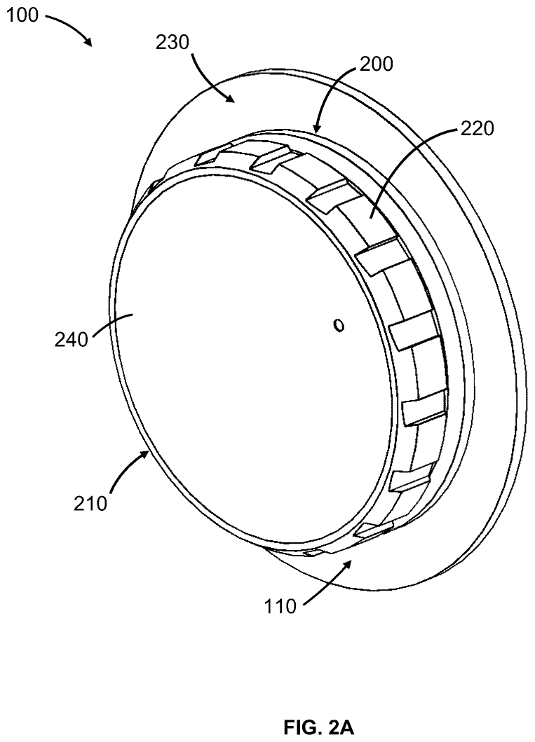

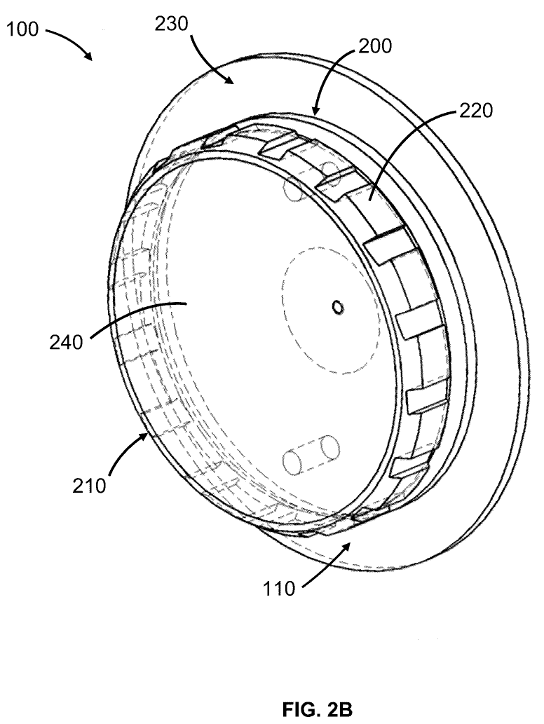

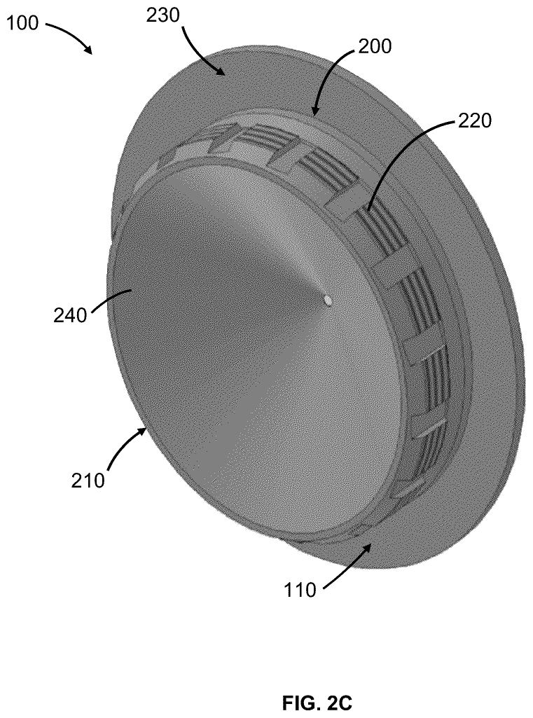

FIGS. 2A-2C depict a rear isometric view of the sampler cone 100, a rear isometric wire-view of the sampler cone 100, and a rear isometric solid-view of the sampler cone 100, respectively. As shown in FIGS. 2A-2C, the shaft 110 may comprise a generally cylindrical body having a proximal shaft end 200, a distal shaft end 210, and an outer sidewall 220 extending between the proximal shaft end 200 and distal shaft end 210. The proximal shaft end 200 may be circular and about a bottom surface 230 of the flange 130. The distal shaft end 210 may be circular and define an opening or cavity 240 of the sampler cone 100. The cavity 240 may be configured to receive or sit flush against an ICP-MS interface component (not pictured). The cavity 240 may also be frustoconical in shape. However, other shapes may be contemplated.

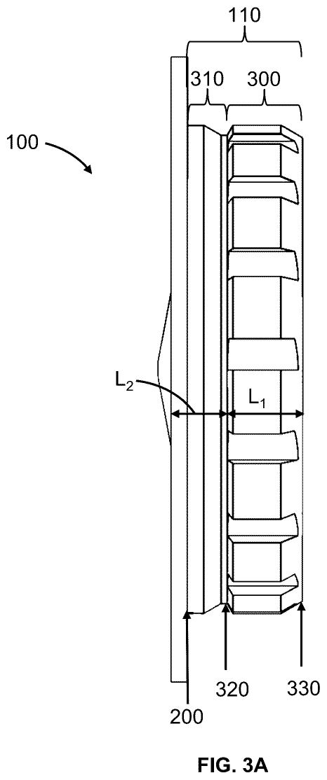

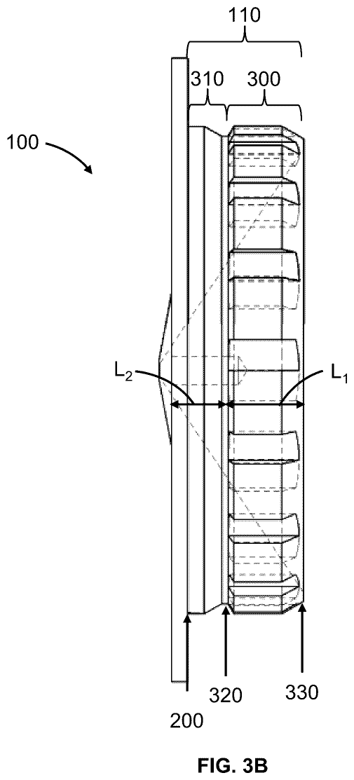

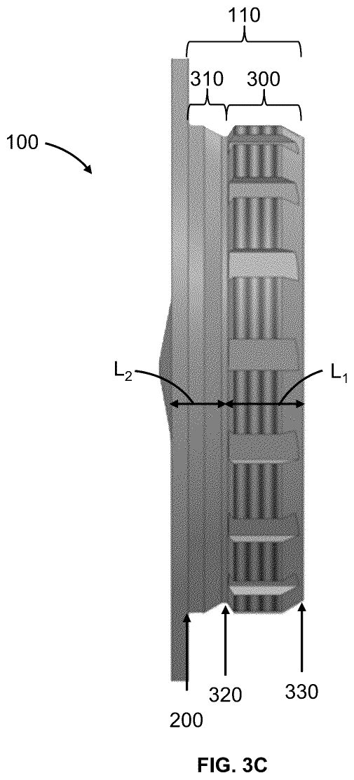

FIGS. 3A-3C depict a first side view of the sampler cone 100, a first side wire-view of the sampler cone 100, and a first side solid-view of the sampler cone 100, respectively. As shown in FIGS. 3A-3C, the shaft 110 may further comprise an engagement portion 300 and a non-engagement portion 310. The engagement portion 300 is configured to interface or engage with a complementary or corresponding interface of an ICP-MS instrument. The engagement portion 300 may extend axially from a proximal engagement end 320 to a distal engagement end 330 having a length L₁. The length L₁ may range from about 3 mm to about 10 mm, and preferably is about 6 mm. The proximal engagement end 320 may be beveled or chamfered to allow a metal gasket or O-ring (not pictured) to be placed onto and received by the shaft 110 of the sampler cone 100. The distal engagement end 330 may be beveled or chamfered to aid the insertion of the sampler cone 100 into the corresponding internal threaded portion of the ICP-MS instrument.

The non-engagement portion 310 may extend axially from the proximal shaft end 200 to the proximal engagement end 320 having a length L₂. The non-engagement portion 310 may connect the engagement portion 300 to the flange 130. In some examples, the non-engagement portion 310 may be configured to receive the metal gasket or O-ring. The length L₂ may range from about 1 mm to about 6 mm, and preferably is about 3.5 mm.

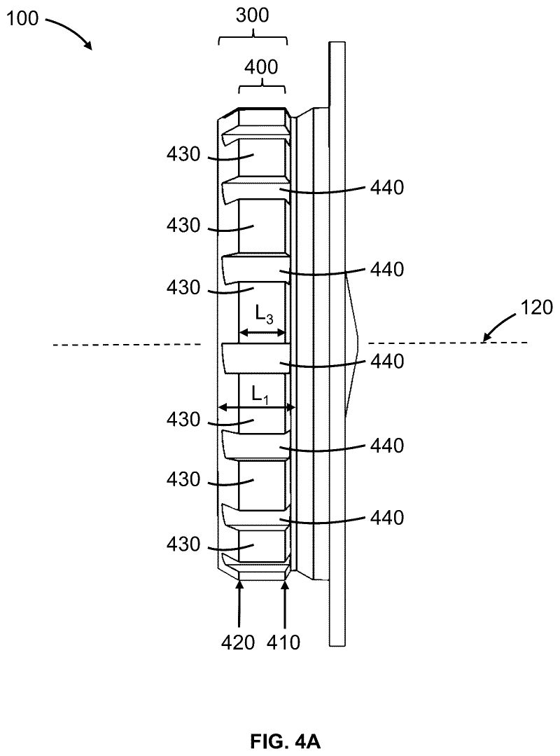

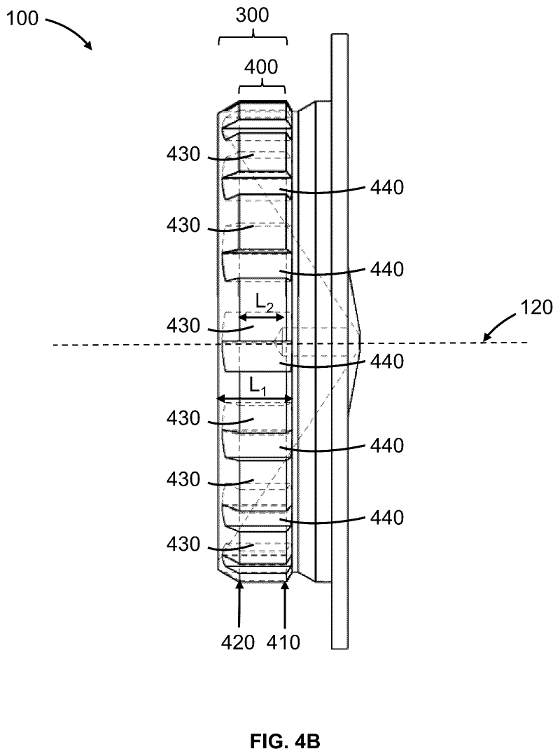

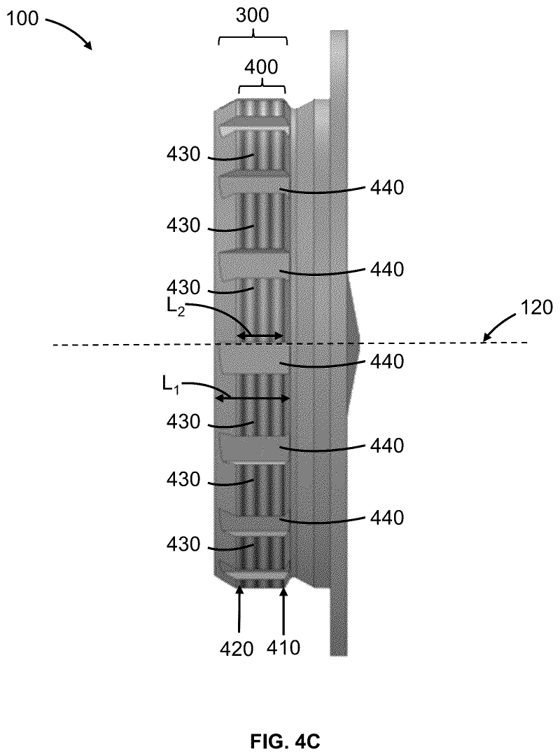

FIGS. 4A-4C depict a second side view of the sampler cone 100, a second side wire-view of the sampler cone 100, and a second side solid-view of the sampler cone 100, respectively. As shown in FIGS. 4A-4C, the engagement portion 300 may further comprise a threaded portion 400 extending axially from a proximal thread end 410 to a distal thread end 420 having a length L₃. As used herein for the sake of convenience and without limitation, “threaded portion” may be referred to as threaded shaft. The threaded portion 400 is configured to interface or engage with a complementary or corresponding internal threaded portion of an ICP-MS instrument and is configured to axially advance the sampler cone 100 into the ICP-MS interface or axially retreat the sampler cone 100 from the ICP-MS interface. In some examples, the length L₃ of the threaded portion 400 may be smaller than the length L₁ of the engagement portion 300, such as when the sampler cone 100 comprises a beveled or chamfered proximal engagement end 320 and/or a beveled or chamfered distal engagement end 330.

The threaded portion 400 may be externally threaded and comprise threads (not pictured) forming a helix in the direction of rotation around the central longitudinal axis 120 beginning at or near the distal thread end 420 and terminating at or near the proximal threaded end 410. The helix (not pictured) may preferably comprise non-continuous threads. As used herein for the sake of convenience and without limitation, “non-continuous threads” may refer to a segmented helical thread pattern having circumferential gaps that segment the threaded portion 400 into threaded regions 430 and unthreaded regions 440. As used herein again for the sake of convenience and without limitation, “continuous threads” may refer to a non-segmented helical thread pattern consisting of one continuous thread without any circumferential gaps. As used herein again for the sake of convenience and without limitation, “threaded regions” may be referred to as thread columns. As used herein again for the sake of convenience and without limitation, “unthreaded regions” may be referred to as gaps.

A thread pattern with non-continuous threads may be preferred on a sampler cone 100 to decrease the likelihood of galling and/or seizing. For instance, when the sampler cone 100 is inserted into the internal threaded portion of the ICP-MS instrument, the metal threads of the sampler cone 100 contact the metal threads of the ICP-MS instrument. The friction between the two metals generates heat and releases small amounts of metal material. As the sampler cone 100 is threaded onto or off the ICP-MS instrument, the small amounts of metal material may get trapped along the threads. The small amounts of metal material may collect throughout the thread surfaces and form lumps. The small amounts of metal material may also continue to wear away the thread surface, resulting in a non-smooth surface on the sampler cone 100. When the sampler cone 100 is re-inserted into or removed from the ICP-MS interface, the sampler cone 100 may not properly engage with the internal threads of the ICP-MS interface. In extreme cases, the sampler cone 100 may seize or fuse with the internal threads of the ICP-MS interface, resulting in unnecessary maintenance and downtime.

By contrast, a thread pattern with non-continuous threads provides a total threaded area that may be less than similarly sized cones with continuous threads. A thread pattern with a relatively smaller total threaded area may decrease the amount of engagement or contact between the threads, which may advantageously decrease the amount of chafing and/or friction, resulting in less material being transferred. Additionally or alternatively, a sampler cone 100 thread pattern with non-continuous threads may provide an outlet for any metal particles that might get caught between the threads. Rather than have those particles get trapped in the threads and continue to wear away the thread surface, the particles can escape the threads and be deposited in those gaps as the cone is threaded onto and off the system.

The thread pattern on the sampler cone 100 may also comprise a combination of non-continuous threads and continuous threads or other suitable configurations, resulting in a thread pattern with a relatively smaller total threaded area compared to similarly sized cones with continuous threads without departing from the principles of the present teachings.

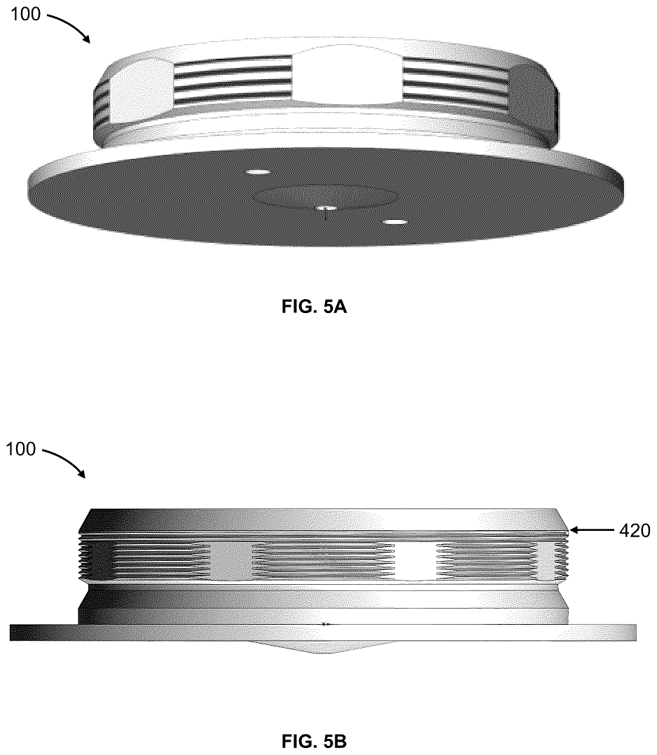

There may be thread patterns configurations where it is actually preferable for the sampler cone to comprise a combination of non-continuous and continuous threads. As shown in FIG. 5A, for example, the sampler cone 500a may comprise a thread pattern with a gradually increasing thread height to facilitate a gradual, less abrupt (smoother) engagement of the threads with the corresponding internal threads of the ICP-MS instrument. The thread pattern according to this example may provide a relatively smaller total thread area by gradually increasing the thread heights. A gradually increasing thread height may be preferable on the thread pattern of the sampler cone to decrease the likelihood of galling by allowing fewer wear surfaces on the threads of the threaded portion.

To facilitate installation of the sampler cone on an ICP-MS instrument, as shown in the third exemplary sampler cone 500b in FIG. 5B, the sampler cone 100 comprising gradually rising and falling thread heights may benefit from a thread pattern with a combination of non-continuous threads and continuous threads to facilitate engagement of the sampler cone 100 with the ICP-MS instrument. For example, the thread pattern may comprise a continuous thread starting at or near the distal thread end 420.

The threaded portion 400 may be fully engaged with the spectrometer or internal threaded surface upon rotation of the sampler cone 100 relative to the ICP-MS instrument by any number of revolutions or by any fraction of a revolution. For example, the threaded portion 400 may be fully engaged with the internal threaded surface upon rotating the sampler cone 100, and hence, engaging the threaded portion 400 with the internal threaded surface, by approximately ½ (one-half) of one full revolution, approximately 1 full revolution, approximately 2 full revolutions, at least 1 revolution, or at least 5 revolutions, among many others.

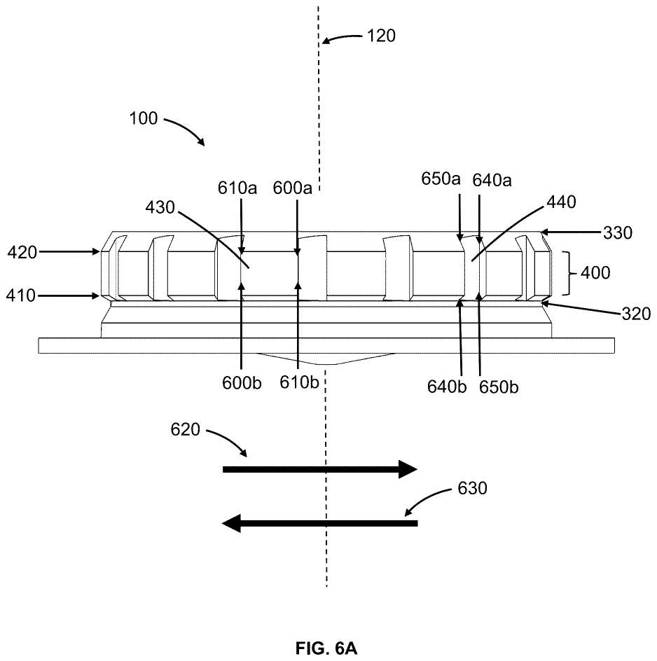

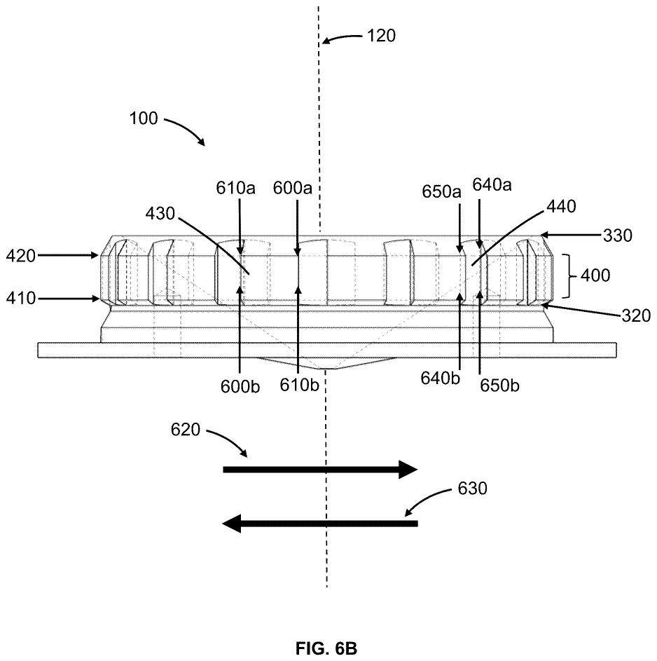

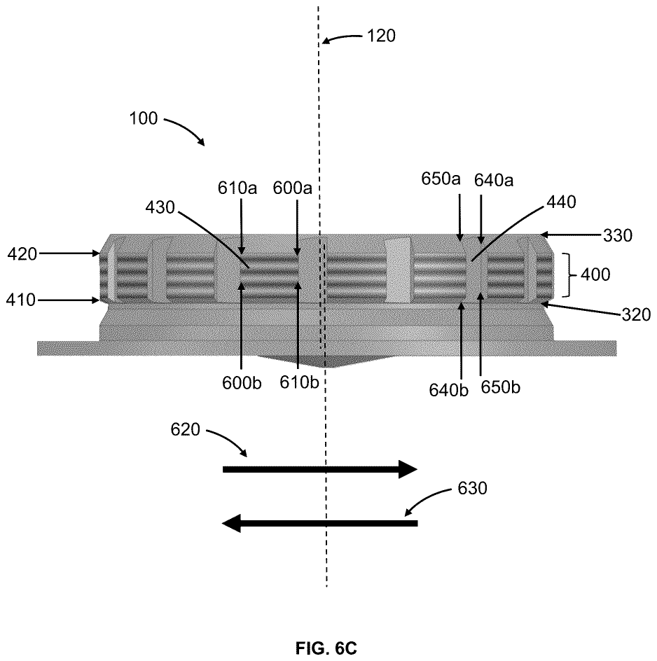

FIGS. 6A-6C depict a third side view of the sampler cone 100, a third side wire-view of the sampler cone 100, and a third side solid-view of the sampler cone 100, respectively. As shown in FIGS. 6A-6C, the threaded shaft 400 may comprise a plurality of threaded regions 430 circumferentially disposed on the outer surface of the threaded portion 400 and separated from each other by a plurality of unthreaded regions 440. The thread pattern comprising a plurality of unthreaded regions 440 provides a total threaded area that may be less than similarly sized cones with continuous threads while still allowing the sampler cone 100 to fully engage with the ICP-MS spectrometer interface.

Each of the threaded regions 430 may comprise a generally rectangular shape extending axially from the proximal thread end 410 to the distal thread end 420, and extending circumferentially from a leading thread edge 600 to a trailing thread edge 610. As used herein for the sake of convenience and without limitation, “leading thread edge” may refer to a thread edge that is positioned ahead of a trailing thread edge relative to the direction of rotation. As used herein again for the sake of convenience and without limitation, “trailing thread edge” may mean a thread edge that is positioned behind a leading thread edge relative to the direction of rotation. As shown by example in FIGS. 6A-6C, if the sampler cone 100 is rotating in a clockwise direction of rotation 620, the leading thread edge 600a is positioned rotationally ahead of the trailing thread edge 610a. In another example, if the sampler cone 100 is rotating in a counterclockwise direction of rotation 630, the leading thread edge 600b is positioned rotationally ahead of the trailing thread edge 610b.

The plurality of unthreaded regions 440 may alternate between the plurality of threaded regions 430 and are similarly circumferentially disposed on the outer surface of the threaded shaft 400. Each of the unthreaded regions 440 may comprise a generally rectangular shape extending axially from at or near the proximal engagement end 320 to at or near the distal engagement end 330, and extending circumferentially from a leading gap edge 640 to a trailing gap edge 650. As used herein for the sake of convenience and without limitation, “leading gap edge” may refer to a gap edge positioned ahead of a trailing gap edge relative to the direction of rotation. As used herein again for the sake of convenience and without limitation, “trailing gap edge” may mean a gap edge that is positioned behind a leading gap edge relative to the direction of rotation. As shown by example in FIGS. 6A-6C, if the sampler cone 100 is rotating in the clockwise direction of rotation 620, the leading gap edge 640a is positioned rotationally ahead of the trailing gap edge 650a. In another example, if the sampler cone 100 is rotating in the counterclockwise direction of rotation 630, the leading gap edge 640b is positioned rotationally ahead of the trailing gap edge 650b.

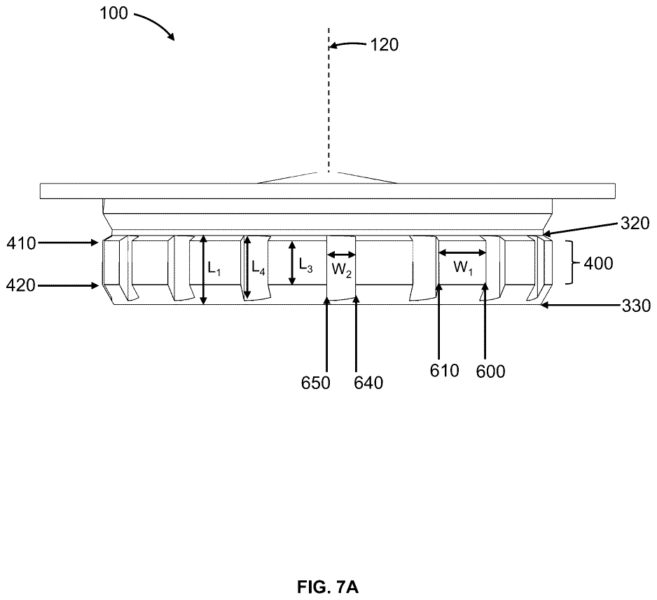

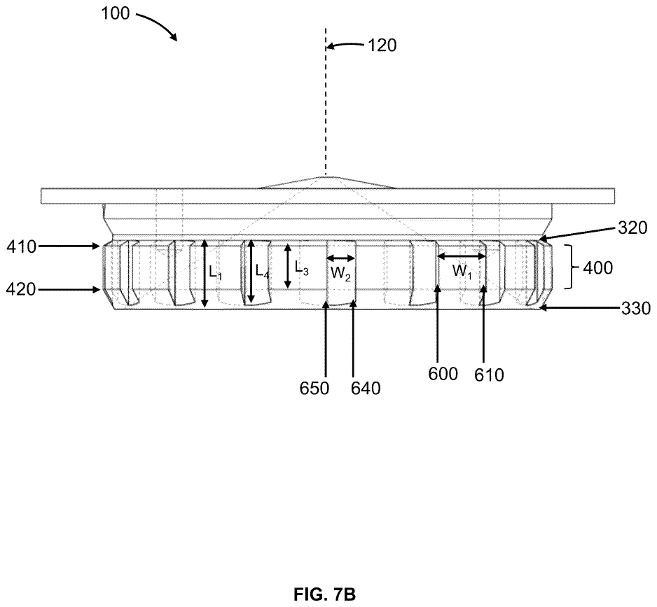

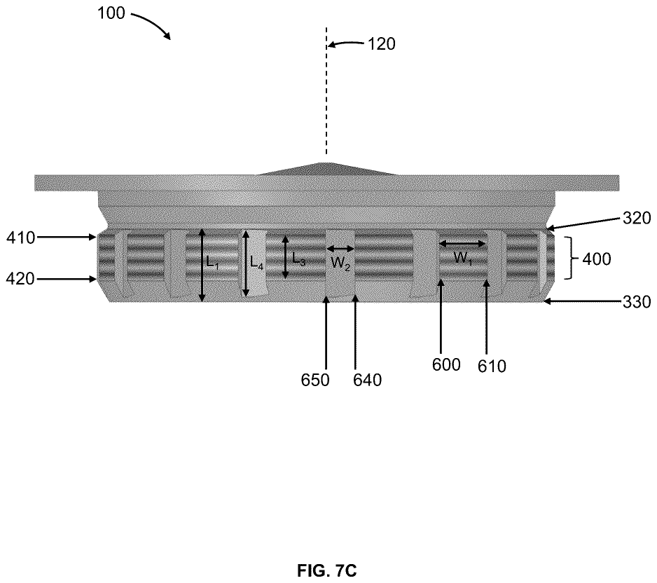

FIGS. 7A-7C depict a fourth side view of the sampler cone 100, a fourth side wire-view of the sampler cone 100, and a fourth side solid-view of the sampler cone 100, respectively. The length L₃ of the threaded regions 430, in this example, is the axial distance from the proximal thread end 410 to the distal thread end 420. The length L₃ may range from about 15% to about 90% of the length L₁. The width W₁ of the threaded region 430, in this example, is the circumferential distance between the leading thread edge 600 and the trailing thread edge 610.

The length L₄ of the unthreaded regions 440, in this example, is the axial distance from at or near the proximal engagement end 320 to at or near the distal engagement end 330. The width W₂ of the unthreaded region 440, in this example, is the circumferential distance between the leading gap edge 640 and the trailing gap edge 650. The length L₄ may range from about 15% to about 100% of the length L₁.

The width W₁ of the threaded regions 430 is preferably equal to the width W₂ of the unthreaded regions 440. Symmetry and equal sizing of the threaded regions 430 and unthreaded regions 440 is preferable for ease of machining the sampler cone 100. However, other configurations may be contemplated where the width W₁ of the threaded regions 430 is not equal to the width W₂ of the unthreaded regions 440.

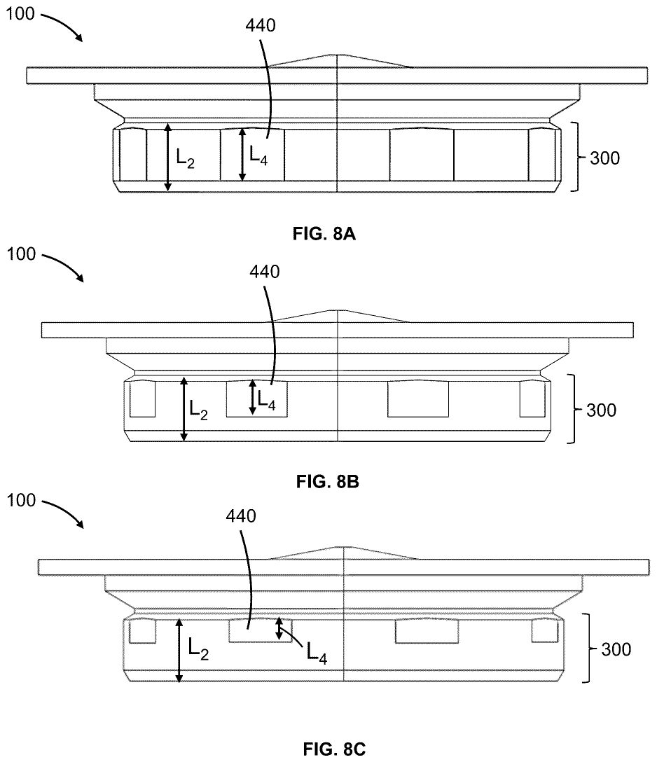

In some examples, the length L₄ of the unthreaded regions 440 is equal to the length L₁ of the engagement portion 300. However, other examples may be contemplated where the length L₄ of the unthreaded regions 440 is less than the length L₁ of the engagement portion 300. As shown in one exemplary sampler cone 100 in FIG. 8A, a thread pattern comprising both continuous and non-continuous threads may have the length L₄ of the unthreaded regions 440 that is less than the length L₁ of the engagement portion 300. The length L₄ of the unthreaded regions 440 may be calculated as a percentage of the length L₁ of the engagement portion 300. As shown in FIG. 8A, the length L₄ of the unthreaded regions 440 may be approximately 90% of the length L₁. As shown in a second exemplary sampler cone 100 in FIG. 8B, the length L₄ of the unthreaded regions 440 may be approximately 60% of the length L₁. As shown in a third exemplary sampler cone 100 in FIG. 8C, the length L₄ of the unthreaded regions 440 may be approximately 20% of the length L₁. The length L₄ of the unthreaded regions 440 may also comprise other percentages not depicted in FIGS. 8A-8C.

It should also be appreciated that the examples shown in FIGS. 8A-8C are provided by way of example simply to illustrate various features related to the unthreaded regions 440 and is not intended to convey anything about the dimensions or proportions of the threads or the sampler cone itself.

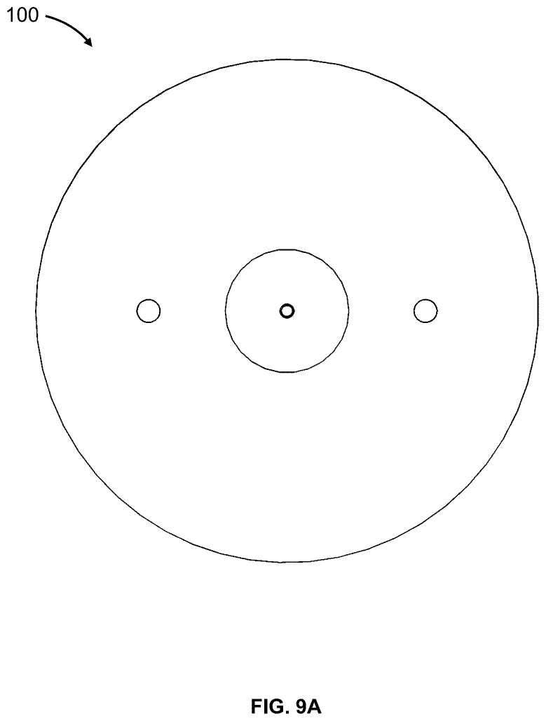

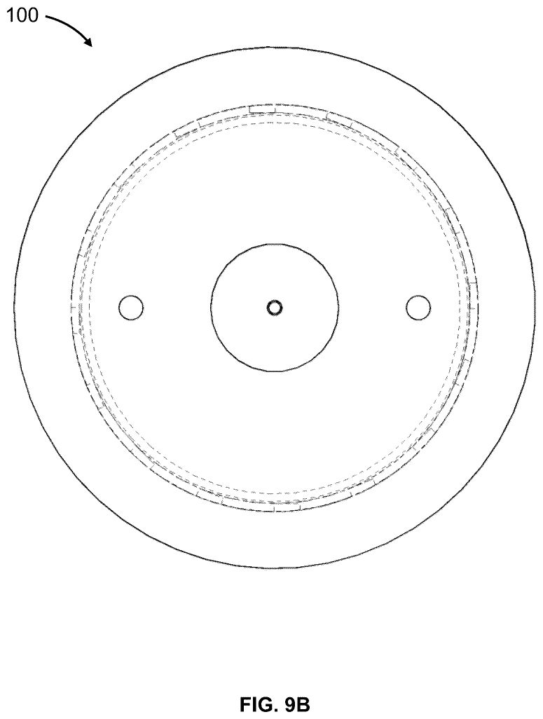

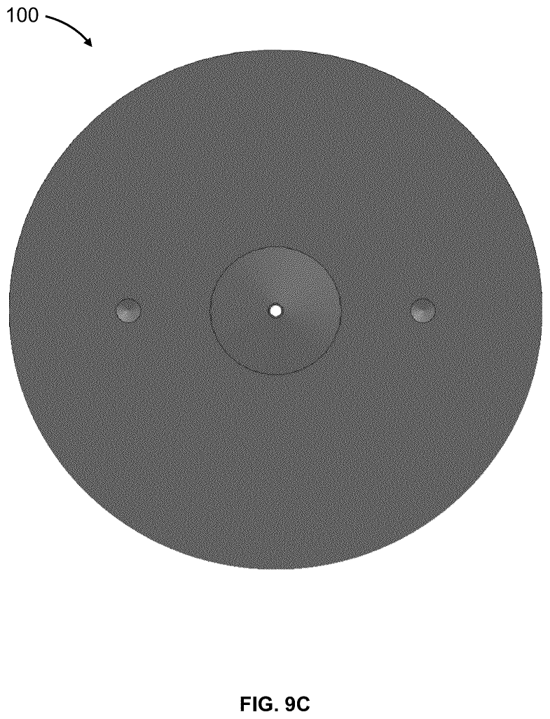

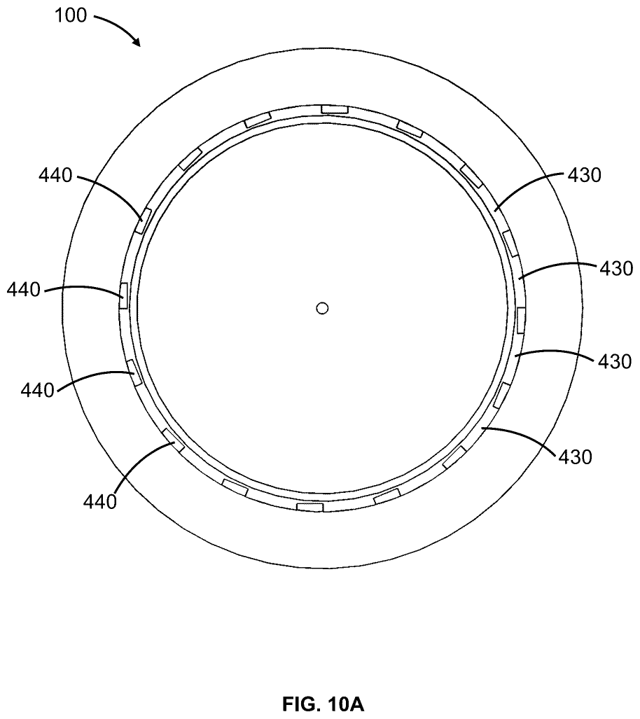

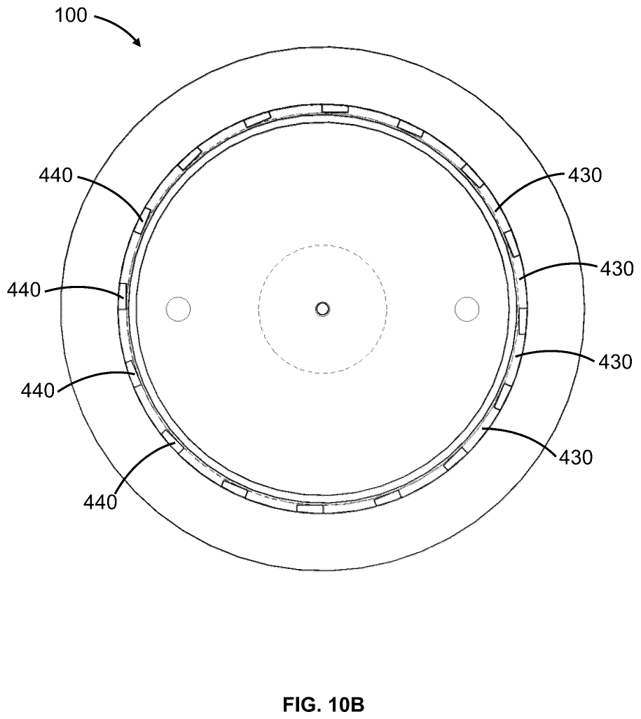

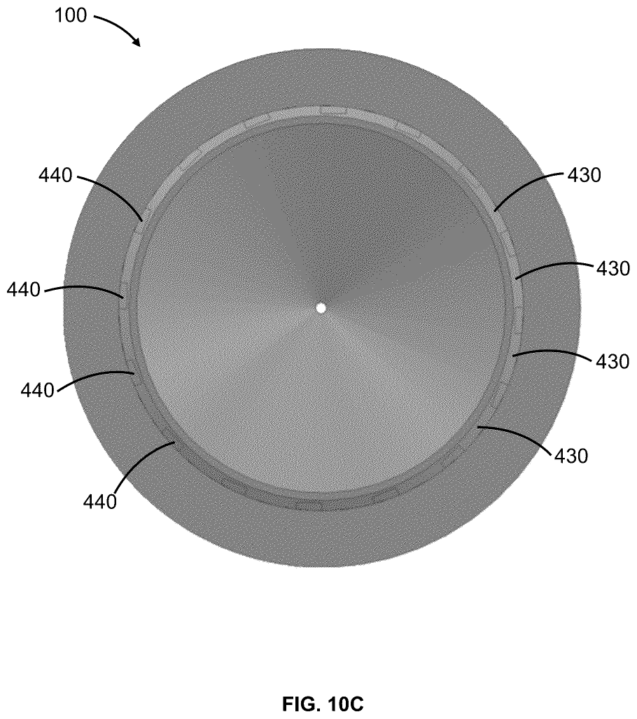

FIGS. 9A-9C depict a front view of the sampler cone 100, a front wire-view of the sampler cone 100, and a front solid-view of the sampler cone 100, respectively. FIGS. 10A-10C depict a rear view of the sampler cone 100, a rear wire-view of the sampler cone 100, and a rear solid-view of the sampler cone 100, respectively. As shown in FIGS. 10A-10C, the sampler cone 100 may have a quantity of threaded regions 430 and a quantity of unthreaded regions 440.

The total area of the threaded regions 430 and the total area of the unthreaded regions 440 is preferably equal for ease of machining the sampler cone 100. However, other configurations may be contemplated where the total of threaded regions 430 is not equal to the total area of the unthreaded regions 440. For example, a thread pattern with a relatively smaller area of threaded regions 430 and a relatively larger area of unthreaded regions may be preferred to prioritize a sampler cone 100 that may reduce friction and decrease the likelihood of galling. Alternatively, a thread pattern with a relatively larger area of threaded regions 430 and a relatively smaller area of unthreaded regions 440 may be preferred to prioritize a sampler cone 100 that fully engages with the internal threaded portion of the ICP-MS instrument while still decreasing the likelihood of galling.

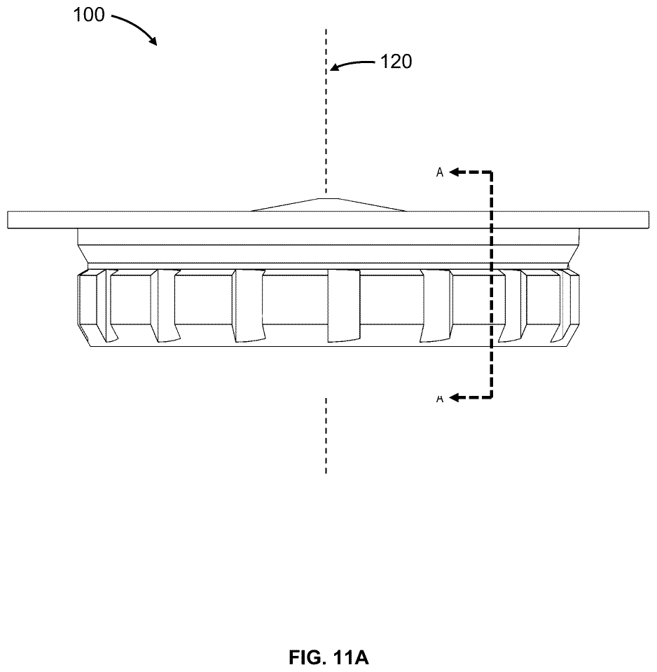

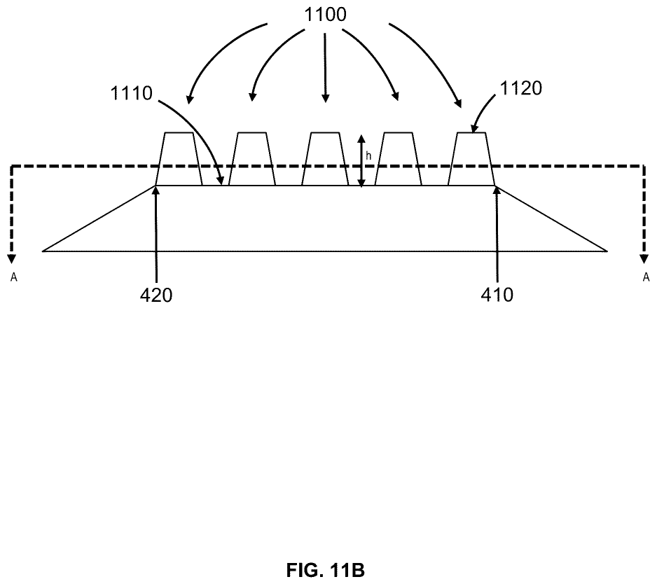

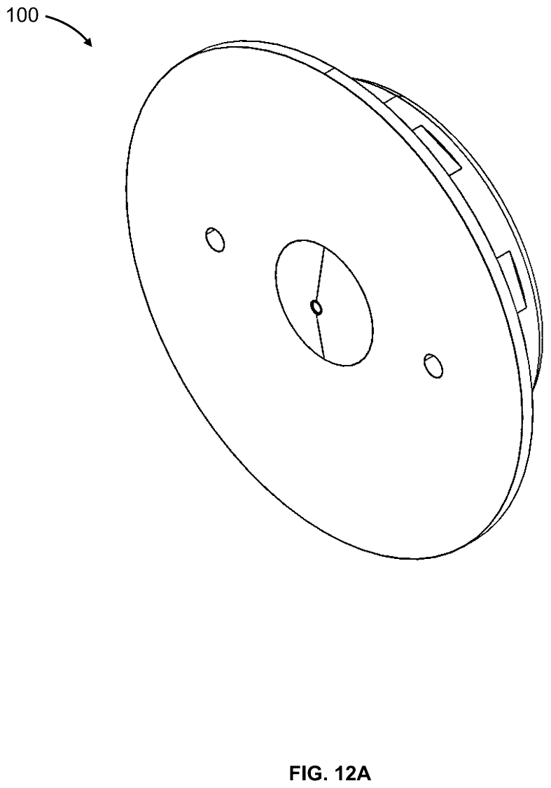

FIG. 11A depicts a side view of the sampler cone 100. FIG. 11B depicts a cross-sectional view of the sampler cone 100 along line A-A. As shown in FIG. 11B, the threaded region 430 may comprise a plurality of threads 1100 axially spaced from the distal thread end 420 to the proximal thread end 410. The plurality of threads 1100 may appear as teeth in the cross-sectional view in FIG. 11B. The threads 1100 are preferably set equally apart axially along the threaded regions 430. The quantity of threads 1100 on the threaded regions 430 may depend on the length of the thread 1100 and the quantity of complete spirals the threads 1100 make rotationally around the threaded shaft 400. It should also be appreciated that the cross-sectional view shown in FIG. 11B is provided by way of example simply to illustrate various features related to the threads 1100 and is not intended to convey anything about the dimensions or proportions of the threads or the sampler cone itself.

Each thread 1100 may project radially outward having a thread height h. The thread height h, in this example, is the radial distance between a root 1110 of the threaded portion 400 and a crest 1120 of the threaded portion 400.

The profile of the external thread may be or otherwise resemble a screw thread, including a triangular thread, a trapezoidal thread, or a sawtooth thread, amongst others. The type of thread pattern selected for the external threads may be the same as or different from the pattern of the internal threads of the corresponding internal threaded portion of the ICP-MS instrument.

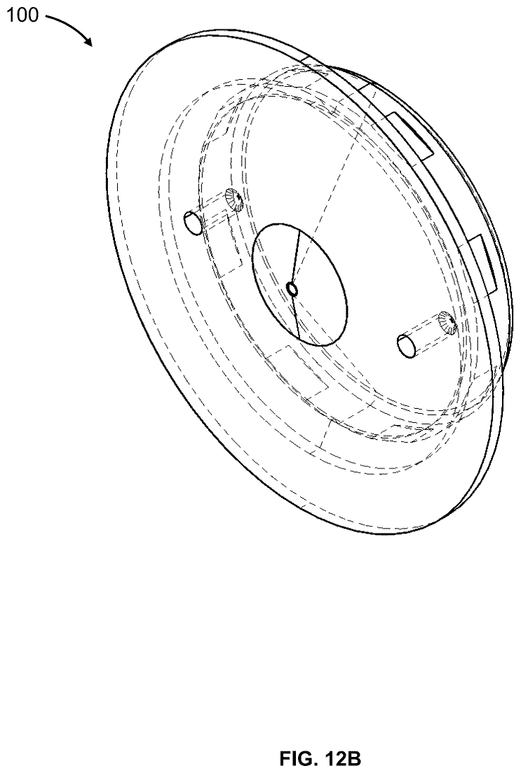

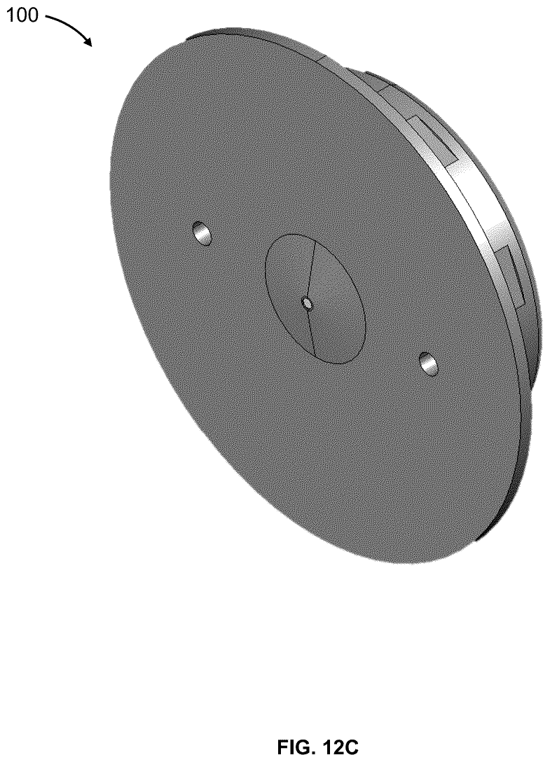

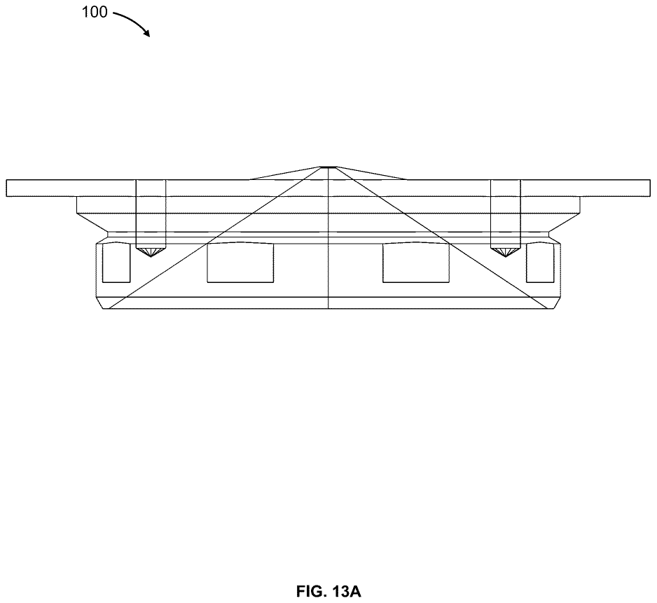

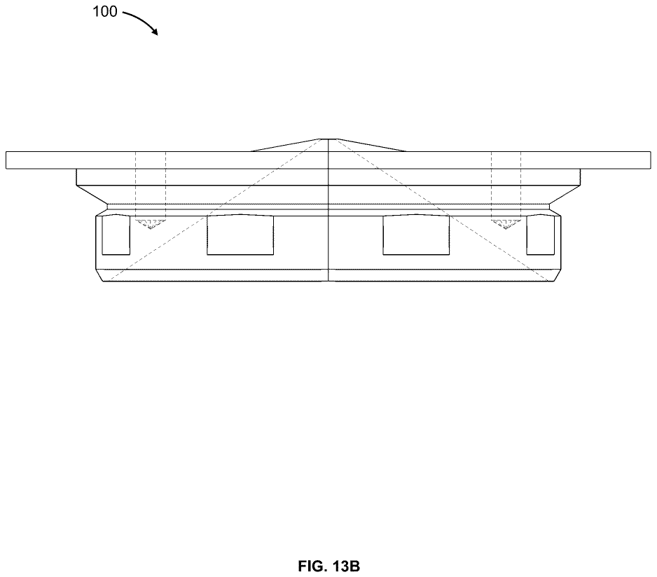

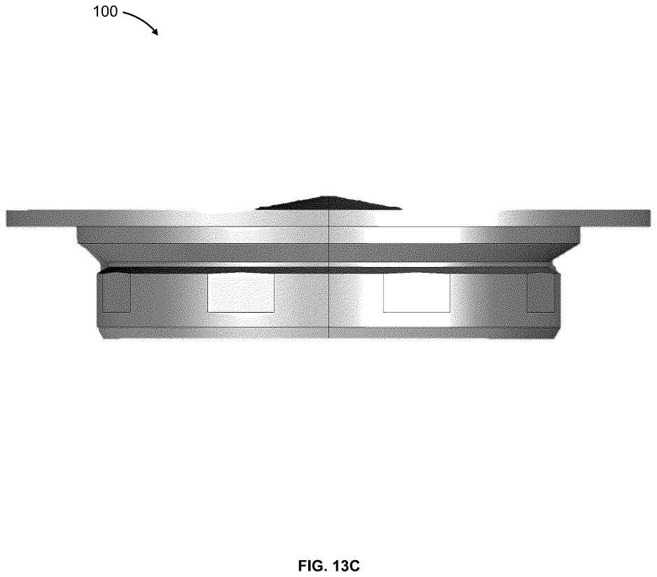

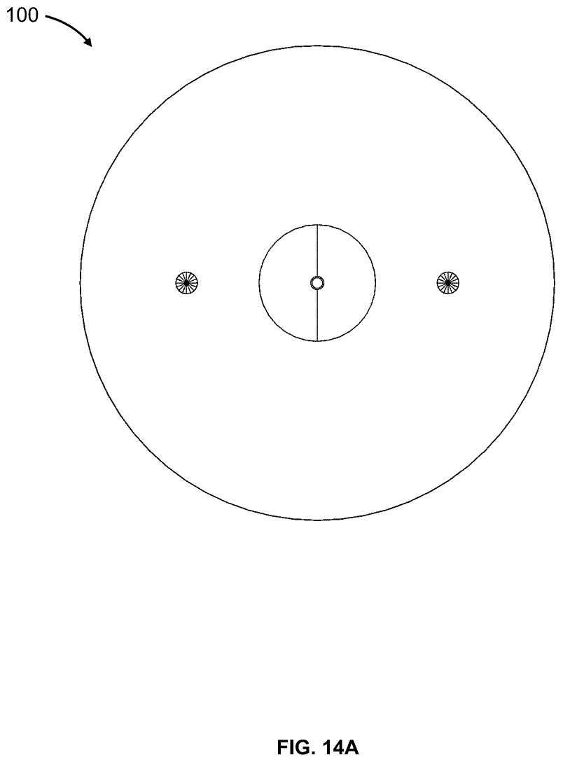

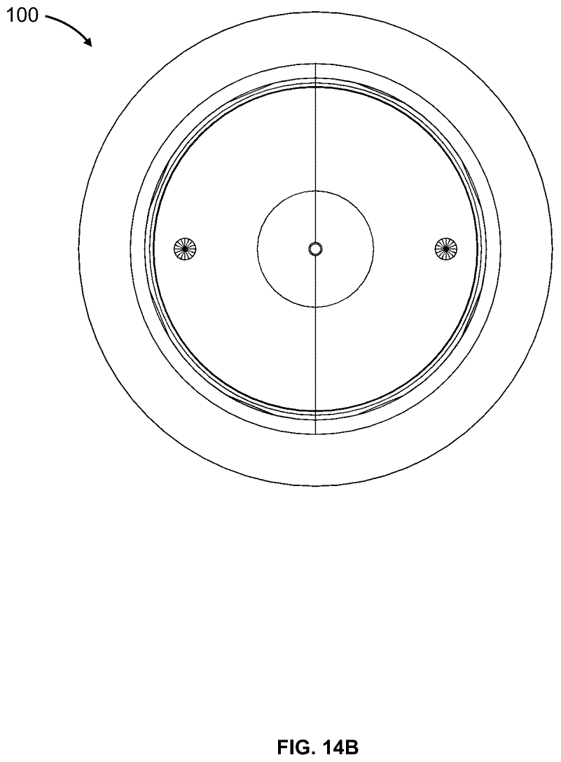

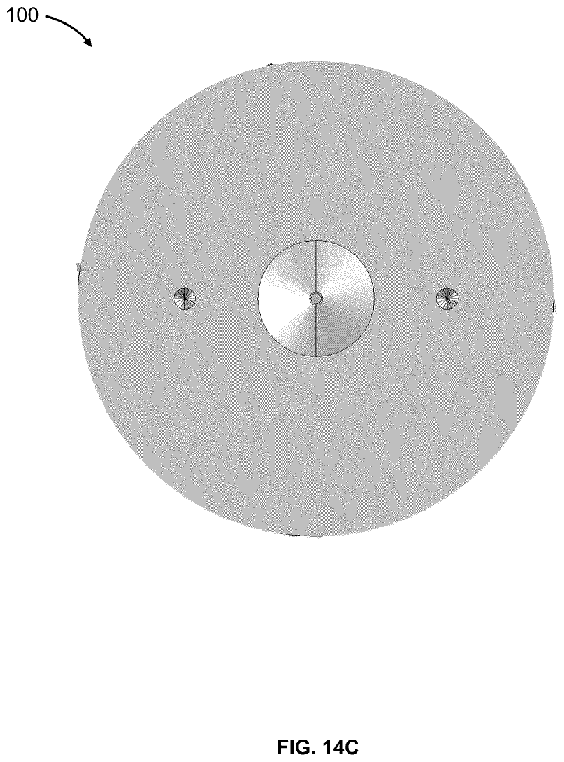

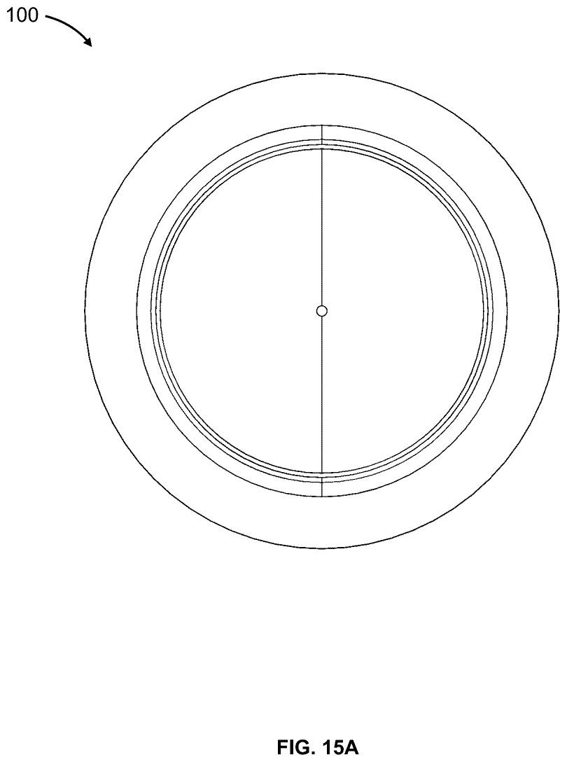

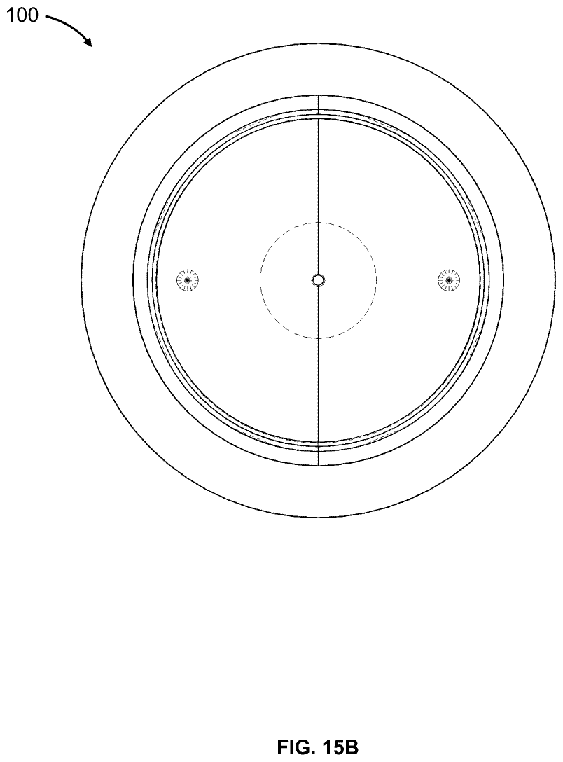

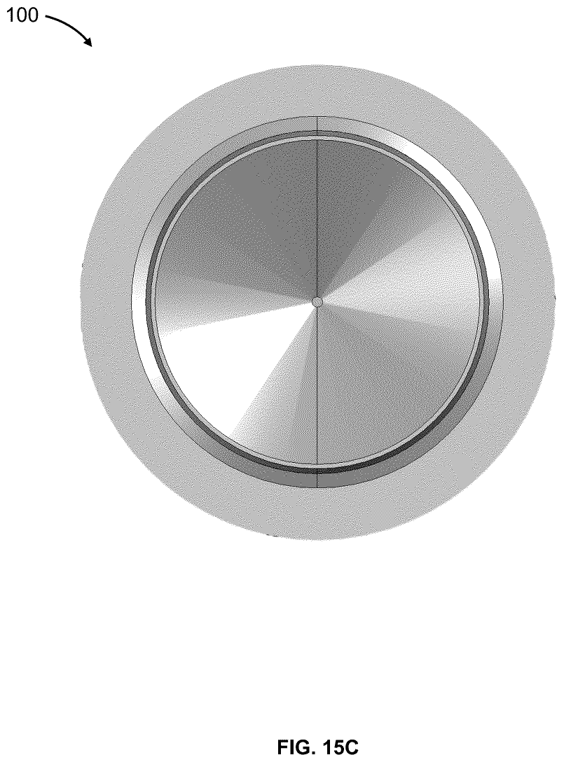

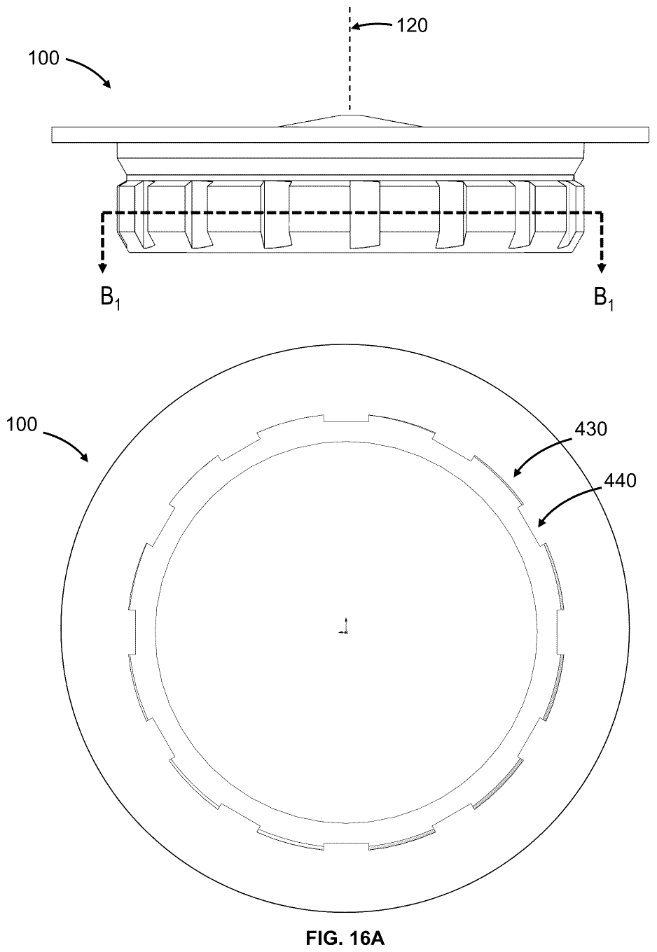

FIGS. 12-15 show another example of the sampler cone 100 with a thread height h that may vary across the width of the thread 1100 to reduce the total threaded area on the threaded shaft 400 while allowing the sampler cone 100 to fully engage with the ICP-MS spectrometer interface. FIGS. 12A-12C depicts an isometric view of the sampler cone 100, an isometric wire-view of the sampler cone 100, and an isometric solid-view of the sampler cone 100, respectively. FIGS. 13A-13C depicts a side view of the sampler cone 100 side wire-view of the sampler cone 100, and a side solid-view of the sampler cone 100, respectively. FIGS. 14A-14C depicts a front view of the sampler cone 100, a front wire-view of the sampler cone 100, and a front solid-view of the sampler cone 100, respectively. FIGS. 15A-15C depicts a rear view of the sampler cone 100, a rear wire-view of the sampler cone 100, and a rear solid-view of the sampler cone 100, respectively.

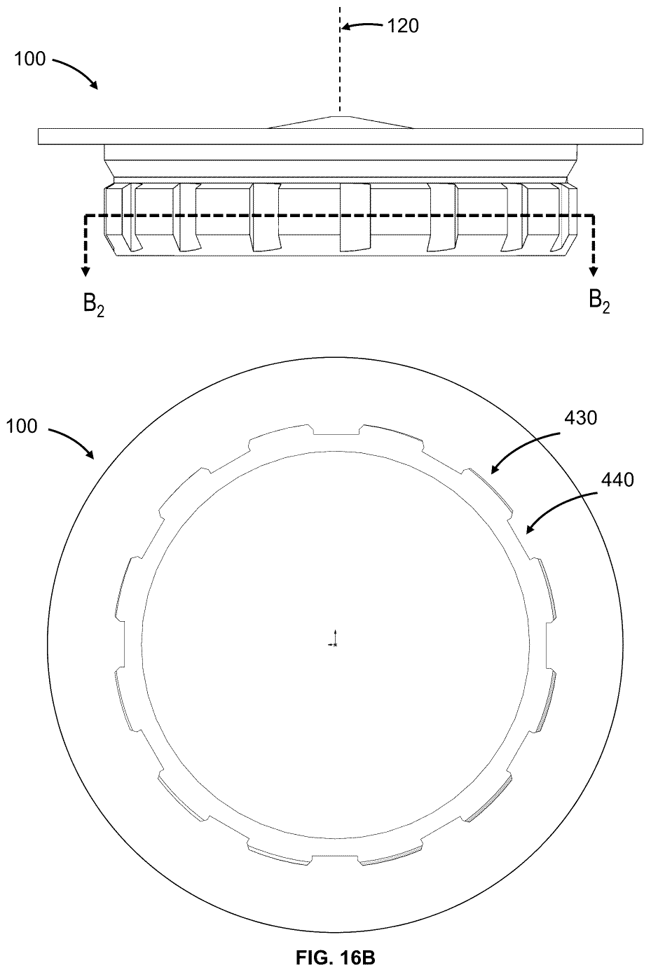

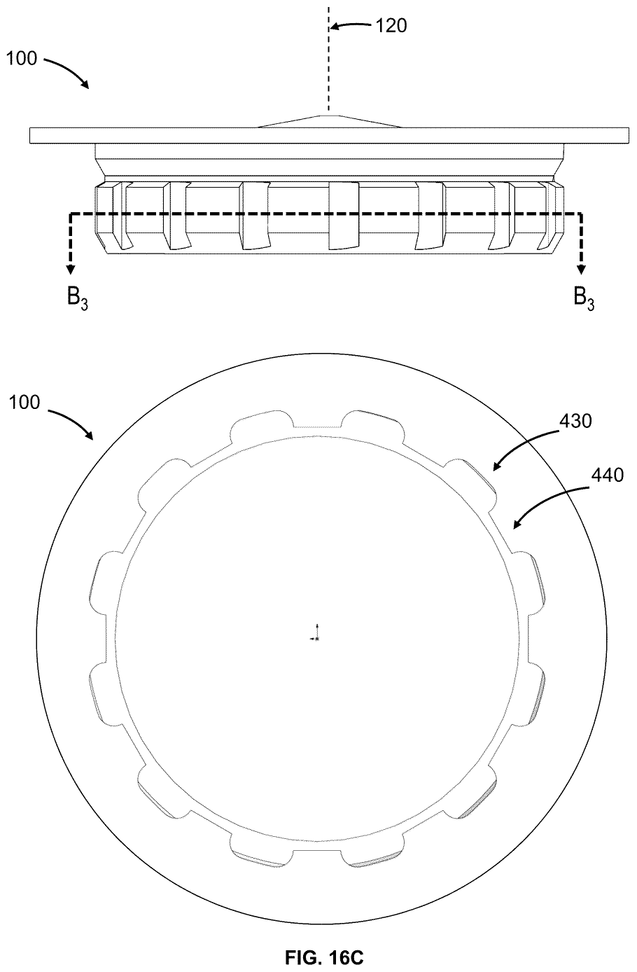

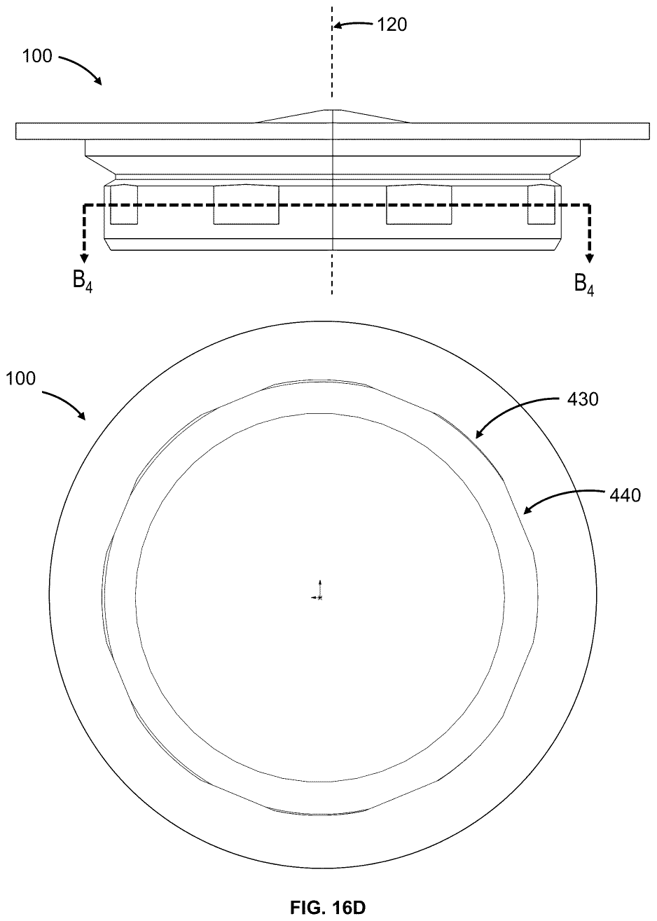

FIGS. 16A-16D depict cross sectional views of the exemplary sampler cone 100. In some examples, the thread height h may vary across the width of the thread 1100 to reduce the total threaded area on the threaded shaft 400 while allowing the sampler cone 100 to fully engage with the ICP-MS spectrometer interface.

For example, FIG. 16A depicts a cross-sectional view perpendicular to the central longitudinal axis 120 of one example of the sampler cone 100 along line B₁-B₁. In this first example of the sampler cone 100 along line B₁-B₁, each thread may comprise a constant or single thread height extending from the leading thread edge 600 to a trailing thread edge 610. A thread pattern with an equal thread height may facilitate successful engagement of the sampler cone 100 with the internal threads of the ICP-MS instrument without encumbrance or difficulty. As seen in FIG. 16A, the constant height of the threads, in this example, result in the leading and trailing thread edges of the threads being generally perpendicular to the outer surface of the shaft.

In the remaining examples of the sampler cone 100, each thread 1100 may comprise a thread height h that varies across the width of the thread 1100. For example, as shown in FIG. 16B, each thread 1100 may have a minimum thread height h₁ and a maximum thread height h_{2.} A thread pattern with a variable thread height h may be preferred to facilitate a gradual, less abrupt engagement of the threads with the corresponding internal threads of the ICP-MS instrument.

FIG. 16B depicts a cross-sectional view perpendicular to the central longitudinal axis 120 of a second example of the sampler cone 100 along line B₂-B₂. In this second example of the sampler cone 100 along line B₂-B₂, the minimum thread height may h₁ may exist at the leading thread edge 600 and/or the trailing thread edge 610. The variable thread height in the B₂ cross section allows for a smoother transition region compared to the thread height h in the B₁ cross section. A gradually increasing thread height may be preferable on the thread pattern of the sampler cone 100 to decrease the likelihood of galling by allowing fewer wear surfaces on the threads of the threaded portion. Additionally or alternatively, a gradually increasing thread height h may be preferred to facilitate a gradual, less abrupt engagement of the threads 1100 with the corresponding internal threads of the ICP-MS instrument. As seen in FIG. 16B, the leading and trailing edges of the threads, in this example, taper from the maximum thread height toward the outer surface of the shaft. The example threads in FIG. 16B thus may be described as having a chamfered leading and trailing edges.

FIG. 16C depicts a cross-sectional view perpendicular to the central longitudinal axis 120 of a third example of the sampler cone 100 along line B₃-B₃. This third example of the sampler cone 100 along line B₃-B₃ shows a similar cross-section as the example shown in B₂. As seen in FIG. 16C, the leading and trailing edges of the threads, in this example, curve from the maximum thread height toward the outer surface of the shaft and meet the outer surface of the shaft at a generally perpendicular orientation. The example threads in FIG. 16C thus may be described as having rounded leading and trailing edges.

FIG. 16D depicts a cross-sectional view perpendicular to the central longitudinal axis 120 of a fourth example of the sampler cone 100 along line B₄-B₄. In this fourth example of the sampler cone 100 along line B₄-B₄, the threads 1100 show an even smoother, even less abrupt transition from the maximum thread height h₂ to the minimum thread height h₁. The leading and trailing edges of the threads, in this example, may gradually transition from the outer surface of the shaft to the maximum thread height. The transition may be linear or curvilinear. The example threads in FIG. 16C thus may be described as having beveled leading and trailing edges or curvilinear (e.g., arc-shaped) leading and trailing edges. In some examples, the threads themselves may be described as curvilinear (e.g., arc-shaped) as they circumferentially extend around the outer surface of the shaft.

The threaded shaft 400 of the sampler cone 100 may be manufactured from a variety of manufacturing methods, including but not limited to, CNC milling, thread machining with milling, thread machining with a lathe, and die cutting, amongst others.

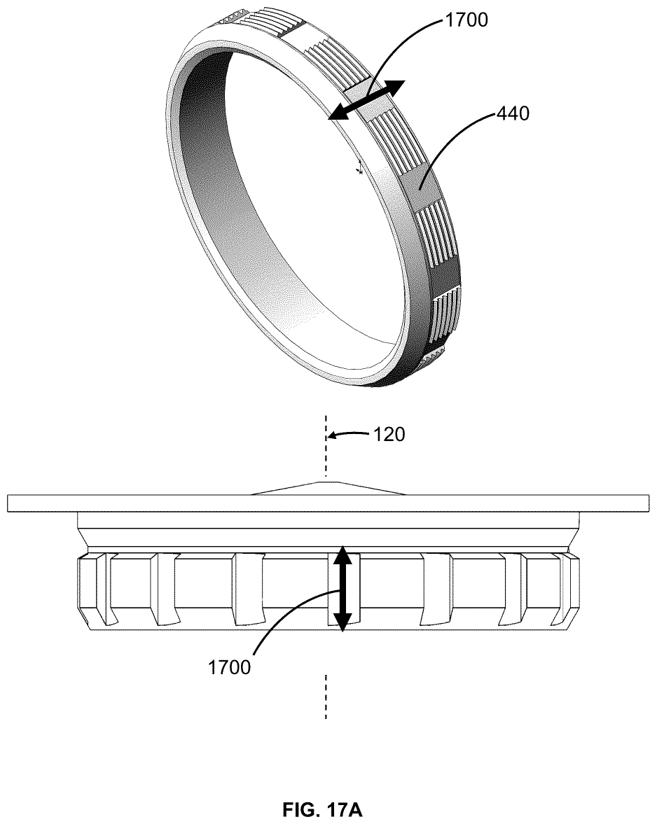

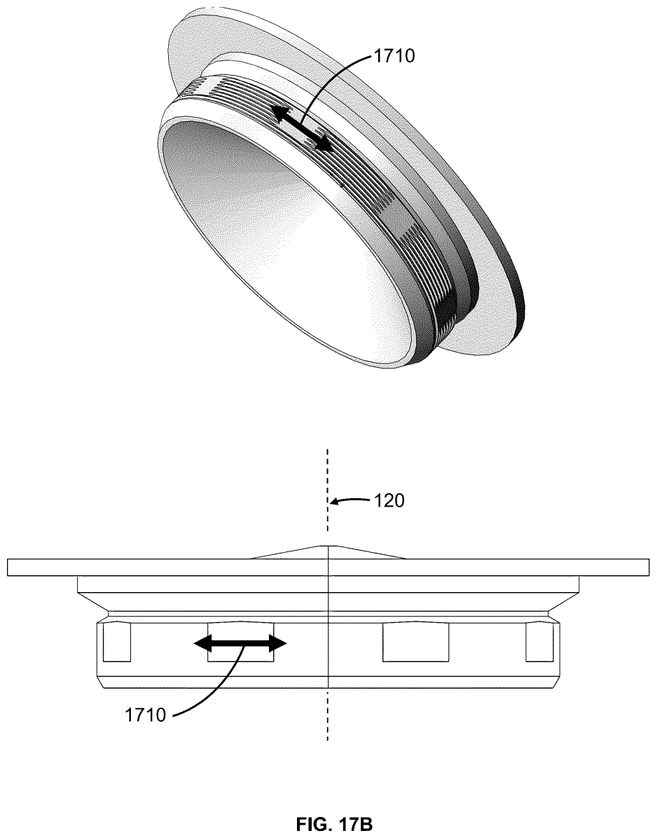

In one example, the threaded shaft 400 may be manufactured using a series of steps. For example, the process of threading the sampler cone 100 with the pattern described herein may start with a first step of machining the threaded portion 400 of the shaft 110 with a continuous external helical thread in the direction of rotation around the central longitudinal axis 120. The process of threading the sampler cone 100 may further include a gap forming step that removes material from the threaded portion 400 of the shaft 110 in a perpendicular machining direction 1700, as shown in FIG. 17A. The perpendicular machining direction 1700 is perpendicular to the direction of the threads 1100 and parallel to the central longitudinal axis 120. The gap forming step may be performed multiple times to create a quantity of unthreaded regions 440 circumferentially disposed on the outer surface of the threaded portion 400 of the shaft 110. The gap forming step may remove material and create unthreaded regions 440 axially extending along the entire length of the threaded portion 400 to create an entirely non-continuous thread. Alternatively, the gap forming step may remove material and create unthreaded regions 440 extending axially along a partial length of the threaded portion 400 to create a helical thread with continuous and non-continuous threads. The continuous thread of the threaded portion 400 may be located at the distal end of the threaded portion 400 to facilitate engagement of the sampler cone 100 with the ICP-MS instrument.

In a second example, the process of threading the sampler cone 100 with the pattern described herein may start with a first step of machining the threaded portion 400 of the shaft 110 with a continuous external helical thread in the direction of rotation around the central longitudinal axis 120. The process of threading the sampler cone 100 may further include a gap forming step that removes material from the threaded portion 400 of the shaft 110 in a parallel machining direction 1710, as shown in FIG. 17B. The parallel machining direction 1710 is perpendicular to the central longitudinal axis 120 and parallel to the direction of the threads 1100. The gap forming step may be performed multiple times to create a quantity of unthreaded regions 440 circumferentially disposed on the threaded portion 400 of the shaft 110. The gap forming step may remove material and create unthreaded regions 440 axially extending along the entire length of the threaded portion 400 to create an entirely non-continuous thread. Alternatively, the gap forming step may remove material and create unthreaded regions 440 extending axially along a partial length of the threaded portion 400 to create a helical thread with continuous and non-continuous threads. The continuous thread of the threaded portion 400 may be located at the distal end of the threaded portion 400 to facilitate engagement of the sampler cone 100 with the ICP-MS instrument.

In a third example, the process of threading the sampler cone 100 with the pattern described herein may start with a first step of machining the threaded portion 400 of the shaft 110 with a continuous external helical thread in the direction of rotation around the central longitudinal axis 120. The process of threading the sampler cone 100 may further include a gap forming step that removes material from the threaded portion 400 of the shaft 110 in a perpendicular machining direction 1700. The gap forming step may be performed a number of times to create a quantity of unthreaded regions 440 circumferentially disposed on the threaded portion 400 of the shaft 110. The process of threading the sampler cone 100 may further include a second gap forming step that removes material from the threaded portion 400 of the shaft 110 in a parallel machining direction 1710. The second gap forming step may be performed a number of times to create a quantity of unthreaded regions 440 circumferentially disposed on the outer surface of the threaded portion 400 of the shaft 110.

The disclosures herein have been presented by way of example with reference to a sampler cone for an ICP-MS instrument. It will be appreciated, however, that the disclosures herein may be implemented in other types of interface cones such as, for example, skimmer cones and hyperskimmer cones. It will also be appreciated that the disclosures herein may be directed to any type of device, whether or not an interface cone for an MS instrument, that is configured with threads for engaging corresponding threads of another device.

What is claimed is:

1. A sampler cone for a mass spectrometry instrument comprising:
a flange defining a first side and a second side opposite the first side;
a cone-shaped tip disposed at the first side of the flange and defining an orifice configured to permit passage of at least a portion of an ion sample;
a threaded shaft disposed at the second side of the flange and defining an outer surface, wherein the threaded shaft comprises:
a plurality of threaded regions circumferentially disposed on an outer surface of the threaded shaft; and
at least one unthreaded region disposed on the outer surface of the threaded shaft between individual threaded regions of the plurality of threaded regions.

2. The sampler cone of claim 1, wherein the threaded shaft further comprises at least one continuous thread circumferentially disposed around the outer surface of the threaded shaft.

3. The sampler cone of claim 2, wherein the plurality of threaded regions are axially disposed between the at least one continuous thread and the flange.

4. The sampler cone of claim 1, wherein threads of the plurality of threaded regions have a first thread height at a first circumferential position of the threaded shaft and a second thread height, different from the first thread height, at a second circumferential position of the threaded shaft.

5. The sampler cone of claim 4, wherein thread height increases from a first thread height to a second thread height between the first circumferential position and second circumferential position.

6. The sampler cone of claim 4, wherein each threaded region of the plurality of threaded regions comprises arc-shaped threads.

7. The sampler cone of claim 1, wherein:
the at least one unthreaded region comprises a plurality of unthreaded regions;
a first unthreaded region of the plurality of unthreaded regions is disposed between a first threaded region of the plurality of threaded regions and a second threaded region of the plurality of threaded regions; and
a second unthreaded region of the plurality of unthreaded regions is disposed between the second threaded region and a third threaded region of the plurality of threaded regions.

8. The sampler cone of claim 1, wherein the threaded shaft has an axial length in a range of about 3 millimeters (mm) to about 10 mm.

9. The sampler cone of claim 1, wherein an axial length of the plurality of threaded regions is in a range of about 15% to about 90% of an axial length of the threaded shaft.

10. The sampler cone of claim 1, wherein an axial length of the at least one unthreaded region is in a range about 15% to up to 100% of the axial length of the threaded shaft.

11. The sampler cone of claim 1, wherein a width of each threaded region of the plurality of threaded regions is different than a width of each unthreaded region of the at least one unthreaded region.

12. The sampler cone of claim 11, wherein the width of each threaded region of the plurality of threaded regions is greater than the width of each unthreaded region of the at least one unthreaded region.

13. The sampler cone of claim 1, wherein an axial length of each threaded region of the plurality of threaded regions is different than an axial length of each unthreaded region of the at least one unthreaded region.

14. The sampler cone of claim 13, wherein the axial length of each threaded region of the plurality of threaded regions is less than the axial length of each unthreaded region of the at least one unthreaded region.

15. The sampler cone of claim 1, wherein the sampler cone is constructed of at least one metallic material.

16. The sampler cone of claim 15, wherein the at least one metallic material comprises at least one of copper, aluminum, platinum, or a nickel alloy.

17. A sampler cone for a mass spectrometry instrument comprising a threaded shaft comprising alternating threaded regions and unthreaded regions circumferentially disposed around an outer surface of the threaded shaft.

18. The sampler cone of claim 17, further comprising at least one continuous thread circumferentially disposed around the outer surface of the threaded shaft wherein the threaded regions comprise arc-shaped threads having a thread height that increases curvilinearly to a maximum thread height between a leading thread edge and a trailing thread edge.

19. A sampler cone for a mass spectrometry instrument comprising:
a flange defining a first side and a second side opposite the first side;
a cone-shaped tip disposed at the first side of the flange and defining an orifice configured to permit passage of at least a portion of an ion sample;
a threaded shaft disposed at the second side of the flange and defining an outer surface, wherein the threaded shaft comprises:
a plurality of threaded regions circumferentially disposed on an outer surface of the threaded shaft, wherein each threaded region of the plurality of thread regions comprise a plurality of threads each having a thread height that increases from a first thread height to a second thread height between a first circumferential position of the threaded shaft and second circumferential position of the threaded shaft;
a plurality of unthreaded regions disposed on the outer surface of the threaded shaft between individual threaded regions of the plurality of threaded regions; and
at least one continuous thread circumferentially disposed around the outer surface of the threaded shaft;
wherein the plurality of threaded regions are axially disposed between the at least one continuous thread and the flange; and
wherein a first unthreaded region of the plurality of unthreaded regions is disposed between a first threaded region of the plurality of threaded regions and a second threaded region of the plurality of threaded regions and a second unthreaded region of the plurality of unthreaded regions is disposed between the second threaded region and a third threaded region of the plurality of threaded regions.

20. The sampler cone of claim 19, wherein the thread height increases curvilinearly between the first circumferential position and the second circumferential position.
